(19) United States
(12) Patent Application Publication
(10) Pub. No.: US 2026/0282092 A1
(43) Pub. Date: Sep. 17, 2026

(54) METHOD AND APPARATUS FOR PROVIDING DYNAMIC UNAVAILABILITY INFORMATION IN WIRELESS LAN COMMUNICATION SYSTEM

(71) Applicant: Samsung Electronics Co., Ltd., Suwon-si (KR)

(72) Inventors: Manasi EKKUNDI, Bangalore (IN); Karthik Srinivasa GOPALAN, Bangalore (IN)

(21) Appl. No.: 19/567,865

(22) Filed: Mar. 16, 2026

(30) Foreign Application Priority Data
Mar. 17, 2025 (IN) 202541023750
Feb. 5, 2026 (IN) 2025 41023750

(51) Int. Cl. H04W 74/0816; H04W 28/02; H04W 84/12

(52) U.S. Cl. CPC H04W 74/0816; H04W 28/0278; H04W 84/12

(57) ABSTRACT

A method performed by an access point (AP) for indicating unavailability information in a wireless local area network (WLAN) communication system is provided. The method includes determining dynamic unavailability time information for a period during which the AP is unable to utilize a duration of transmission opportunity and the dynamic unavailability time information includes at least one of a start time of unavailability time slot or a duration of unavailability; indicating the dynamic unavailability time information in a control frame; and transmitting, to at least one non-AP station, the control frame.

### CROSS-REFERENCE TO RELATED APPLICATION(S)

This application is based on and claims priority under 35 U.S.C. § 119 (a) of an Indian Provisional patent application No. 202541023750, filed on Mar. 17, 2025, in the Indian Patent Office, and of an Indian Complete patent application No. 202541023750, filed on Feb. 5, 2026, in the Indian Patent Office, the disclosure of each of which is incorporated by reference herein in its entirety.

### BACKGROUND

### 1. Field

The disclosure relates to a wireless local area network (LAN) communication system. More particularly, the disclosure relates to a method and apparatus for providing dynamic unavailability information in a wireless LAN communication system.

### 2. Description of Related Art

Wi-Fi Access Points (APs) are responsible for providing wireless network connectivity to its associated devices by performing essential functions such as channel access coordination, beacon transmission, association management, and data forwarding. Modern APs, whether standalone routers, enterprise access points, or embedded AP functions in computing equipment, commonly contain multiple wireless radio systems within the same hardware platform. In many deployments, an AP may integrate technologies such as Wi-Fi (multiple bands), Bluetooth, Zigbee, Thread, near field communication (NFC), or proprietary radio frequency (RF) systems, all operating concurrently within the same physical enclosure. Because these radios often share antennas, RF front-end components, local oscillators, and processing resources, simultaneous activity can cause internal interference. This internal interference, known as In-Device Coexistence (IDC), occurs when the operation of one radio impairs the operation of another radio inside the same AP hardware.

Additionally, modern smartphones and mobile devices support a variety of wireless technologies including Wi-Fi, Bluetooth, Ultra-Wideband (UWB), Cellular (fourth generation (4G)/fifth generation (5G)/sixth generation (6G)), Wi-Fi Direct/peer-to-peer (P2P), and others. To support user applications, smartphones often operate as an AP (also referred to as Mobile-AP, Soft-AP or Wi-Fi hotspot) while simultaneously supporting these additional technologies. However, concurrent operation of multiple wireless technologies within the same device leads to IDC issues, where an activity on wireless technology forces temporary unavailability or performance degradation on another wireless technology.

However, when the AP itself becomes unavailable due to such coexistence events, Wi-Fi Stations (STAs) attempting to communicate with the AP experience failed transmissions, missing acknowledgements, retransmissions, reduced data rates, higher latency, and increased power consumption.

The current implementations, where in Institute of Electrical and Electronics Engineers (IEEE) 802.11bn (Ultra-High Reliability (UHR)) Task Group has introduced mechanisms, such as the Initial Control Frame (ICF) and Initial Control Response (ICR) frame that allow a Wi-Fi stations or non-AP stations signals its unavailability resulting from an IDC event. These mechanisms form the foundation of Dynamic Unavailability Operation (DUO) mode, which is well-defined for non-AP stations. However, none of these mechanisms are designed for, or applicable to, an AP and or for both AP and non-AP stations simultaneously, which behave fundamentally differently and have additional responsibilities.

Therefore, there is a need for new method, signaling formats, frame designs, and operational modes that allow an AP or a non-AP station to indicate its own unavailability due to periodic or aperiodic coexistence events and notify all associated stations and APs, and optionally unassociated stations, ensuring higher reliability and reduced power consumption for both AP and non-AP stations in a Wi-Fi network.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for indicating unavailability information in a Wi-Fi system.

Additional aspects will be set forth in part in the description which follows and, in part, will be apparent from the description, or may be learned by practice of the presented embodiments.

In accordance with an aspect of the disclosure, a method performed by an access point (AP) for indicating unavailability information in a wireless local area network (WLAN) communication system is provided. The method includes determining dynamic unavailability time information for a period during which the AP is unable to utilize a duration of transmission opportunity and the dynamic unavailability time information includes at least one of a start time of unavailability time slot or a duration of unavailability, indicating the dynamic unavailability time information in a control frame, and transmitting, to at least one non-AP station, the control frame.

In accordance with another aspect of the disclosure, an access point (AP) indicating its unavailability in a wireless local area network (WLAN) communication system is provided. The AP includes memory, including one or more storage media, storing one or more computer programs, a wireless transceiver configured to communicate with at least one external device, and at least one processor communicatively coupled to the memory and the wireless transceiver, wherein the one or more computer programs include computer executable instructions that, when executed by the at least one processor individually or collectively, cause the AP to determine dynamic unavailability time information for a period during which the AP is unable to utilize a duration of transmission opportunity, the dynamic unavailability time information includes at least one of a start time of unavailability time slot or a duration of unavailability, indicate the dynamic unavailability time information in a control frame, and transmit, to at least one non-AP station, the control frame.

In accordance with another aspect of the disclosure, a method performed by a non-access point (AP) station for indicating unavailability information in a wireless local area network (WLAN) communication system is provided. The method includes determining, by the non-AP station, dynamic unavailability time information for a period during which the AP is unable to utilize a duration of transmission opportunity and the dynamic unavailability time information includes at least one of a start time of unavailability time slot or a duration of unavailability, indicating the dynamic unavailability time information in a control frame, and transmitting, to at least one AP, the control frame.

In accordance with another aspect of the disclosure, a non-AP station indicating its unavailability in a wireless local area network (WLAN) communication system is provided. The non-AP station includes memory, including one or more storage media, storing one or more computer programs, a wireless transceiver configured to communicate with at least one external device, and at least one processor communicatively coupled to the memory and the wireless transceiver, wherein the one or more computer programs include computer executable instructions that, when executed by the at least one processor individually or collectively, cause the non-AP station to determine dynamic unavailability time information for a period during which the non-AP station is unable to utilize a duration of transmission opportunity and the dynamic unavailability time information including at least one of a start time of unavailability time slot and a duration of unavailability, indicate the dynamic unavailability time information in a control frame, and transmit, to at least one AP, the control frame.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment of a Wi-Fi system for indicating unavailability information, according to an embodiment of the disclosure;

FIG. 2 illustrates an example of hardware configuration of APs or non-AP stations, according to an embodiment of the disclosure;

FIG. 3 illustrates a flow chart illustrating a method for indicating unavailability of an AP in a Wi-Fi system, according to an embodiment of the disclosure;

FIGS. 4A and 4B illustrate sequence diagrams for indicating unavailability when the unavailability start time is within or outside the transmission opportunity respectively, according to various embodiments of the disclosure;

FIG. 5 illustrates a sequence diagram illustrating the method for indicating TXOP duration in a control frame, according to an embodiment of the disclosure;

FIG. 6 illustrates a flow chart illustrating a method for indicating unavailability information of a non-AP station in a Wi-Fi system, according to an embodiment of the disclosure;

FIGS. 7A and 7B illustrate sequence diagrams illustrating the method of an AP indicating unavailability feedback in a control frame, according to various embodiments of the disclosure;

FIGS. 8A and 8B illustrate sequence diagrams illustrating frames carrying the method of feedback of unavailability in management or control frames followed by an ICF-ICR frame exchange, according to various embodiments of the disclosure; and

FIGS. 9A and 9B illustrate sequence diagrams illustrating the method of handling multiple unavailability report handling at non-AP stations, according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Popular applications such as a Mobile-AP or a Soft-AP used for multiple technologies and interfaces that a smartphone support, enable users to use the smartphone as a Wi-Fi AP while supporting other technologies like Bluetooth/UWB, Cellular (5G/4G/6G), peer-to-peer (P2P) Wi Fi and so on. Many of these technologies operate on similar frequencies and may use shared radio resources. Hence when the smartphone is busy with other activities (like Bluetooth or P2P), a Mobile-AP operation becomes unavailable on Wireless Local Area Network (WLAN) channels. Such an event can be termed as a Co-existence event (Co-ex Event). The issues due to such Co-ex events are called the In-Device Coexistence (IDC) issues and they can cause increased power consumption at stations (STA) and Mobile-AP with performance degradation. An increased power consumption at stations (STA) and Mobile-AP is caused when a Mobile-AP becomes unavailable due to Co-ex Event and STA may keep retransmitting the packet due to a missing ack from a Mobile-AP, further, in turn causes reduced data rate of retransmissions due to rate adaptation and causes longer transmission times, increased channel access time and more transmit energy consumption. A Mobile-AP also gets impacted due to reduced data rates of STAs in subsequent retransmissions, hence causes increased reception time and longer wait times causing higher energy consumption. Furthermore, when the performance degradation occurs, the current data packet is not acknowledged, and the future data packets get impacted due to reduced data rates caused by rate adaptation algorithms.

Additionally, the nature of the Co-ex event can mainly be of two types of periodic Co-ex event and aperiodic Co-ex event. When the Co-ex event can be periodic in nature, and it is possible to indicate the periodicity, duration and other related aspects to the impacted STA through signaling. For instance, the existing mechanisms in 802.11 specification like P2P Target-wake-Time (TWT) can be used to indicate the same and an AP can utilize such mechanisms to indicate periodic unavailability. The aperiodic Co-ex events are more sudden or sporadic in nature and these need to be communicated at the moment when a transmission is going to be initiated by the Mobile-AP or with the Mobile-AP and hence can be indicated at a Transmission Opportunity level (TXOP level). Therefore, Mobile-AP and AP which also supports multiple technologies with shared radio resources and limited battery also gets impacted due to Aperiodic Co-ex events like non-AP stations.

Ultra-High Reliability (UHR) Task group of 802.11 Standards Working group is currently working to define the 802.11bn specifications and has defined a few solutions to handle the IDC issues when they occur at the non-AP stations. An Initial Control Frame (ICF)-Initial Control Response (ICR) frame mechanism is introduced where the AP solicits the non-AP station about its unavailability information due to an IDC event through the ICF-ICR.

In an existing scenario of an AP transmitting Buffer Status Report Poll (BSRP) as ICF that solicits unavailability information from a non-AP station. The AP transmits Buffer Status Report Poll (BSRP) as ICF which solicits a non-AP station to send Multi-STA-Block Ack (M-STA-BA) as an ICR which contains the unavailability information. For another instance, in another existing scenario of a non-AP station alternatively sending a BSRP as an ICF as a TXOP holder with unavailability information. Further the unavailability information comprises the unavailability start time and duration which is contained in 9 bits with a granularity of 64 us. For instance, in M-STA-BA a special feedback per association identifier (AID) traffic identifier (TID) info is defined which contains unavailability information. Details of Per AID TID info are defined. (AID 11=2008 or AID 11 of STA, acknowledgment (Ack) Type=0, TID=13). Another instance in BSRP Trigger Frame (TF) can indicate if the responding Physical Protocol Data Unit (PPDU) is in non-HT (High Throughput) duplicate format or UHR Trigger Based (TB) PPDU, a Special User info field with AID 12=2008 can indicate if the field is carrying Co-ex unavailability information. A STA operating in this mode where it can indicate its unavailability information is called a Dynamic Unavailability Operation (DUO) mode. Hence, the solutions defined so far in 802.11 bn task group are to indicate unavailability information by a non-AP station in BSRP as ICF or in M-STA-BA as ICR in response to BSRP ICF from AP for a non-AP station. None of these solutions have had the impact when a Mobile-AP needs to indicate unavailability information. The IDC handling will be different for an AP and a non-AP station and special consideration need to be taken to define the same for a Mobile-AP or AP. For yet another instance, the existing frame format of a BSRP Trigger Frame. The trigger frame has a frame format that has a common information and a list of user information fields. The user info field also has provision for a special user info field identified by the AID 12 value. The common information is modified in UHR specifications to include additional information like when Bit 20-21 value is set to 3, it shall solicit a non-HT duplicate PPDU as a response.

Hence, the current ongoing proposal and agreements in 802.11bn task group discuss how a non-AP station as a TXOP holder or a TXOP responder can indicate unavailability information through an ICF and ICR mechanism. They further discuss the detailed design of BSRP as ICF and M-STA-BA as ICR for a non-AP station but the design of IDC handling is not the same between a non-AP station and an AP or a Mobile-AP. The requirements to be considered to design IDC handling for an AP or a Mobile-AP which are different from the requirements for a non-AP station design may include: (1) an AP or a Mobile-AP needs to inform unavailability information to all the supporting STAs in its BSS, (2) an AP or a Mobile-AP also needs to inform relevant information to un-associated STA, (3) unavailability information needs to be sent in unsolicited ways by an AP or a Mobile-AP as its unavailability impacts all the STAs, (4) indicate unavailability information by an AP or a Mobile-AP apart from regular ICF-ICR as it serves as an opportunity to inform all impacted STAs and (5) handling of multiple unavailability is reported by a non-AP station.

In an embodiment, the disclosure provides a system and method of providing dynamic unavailability operation indication in an AP or a Mobile-AP. According to a first embodiment, the disclosure discloses a system and method that provides first component that includes a design of indicating unavailability information by an AP or a Mobile-AP. The first component includes:
1.1 ICF design
   1.1.1 Conditions under which an ICF can be sent
   1.1.2 ICF Frame Format design
   1.1.3 ICF Frame Format and Conditions of a non-AP station to solicit unavailability information from an AP or a Mobile-AP
1.2 ICR design (Frame format design of ICR)
1.3 Unavailability information in response to (MAC Protocol Data Unit) M-PDU transmission
1.4 Unsolicited Announcement of Unavailability Information

Further, in the embodiment, the disclosure provides a system and method of providing dynamic unavailability operation indication in an AP or a Mobile-AP. According to a second embodiment, the disclosure discloses a system and method that provides second component that includes procedures at a non-AP station to handle an AP or a Mobile-AP unavailability. The proposed second component includes unavailability report handling at a non-AP station.

In some embodiments per existing art, the first component condition includes a design of indicating unavailability information by an AP or a Mobile-AP. Further the first component considers conditions under which an ICF can be sent. The condition required for sending ICF in a non-AP station includes triggering BSRP as an ICF which according to existing art operates in DUO Mode which is a TXOP holder indicates in a BSRP Trigger frame whether it is unavailable after a specific point in time and, if known, for how long it is unavailable. Further, the TXOP holder transmits BSRP Trigger frame only under certain conditions like if there is an Uplink data to transfer at non-AP station. The conditions are to ensure restriction on a non-AP station to avoid sending BSRP with unavailability and flooding the medium which can impact the performance of other devices. In another embodiment, this can be achieved by restricting the frequency of ICF transmissions to a pre-defined threshold by a non-AP station. Further, the triggering of BSRP as an ICF also comprises of an AP. According to the existing art, an AP sends BSRP trigger frame as an ICF to solicit unavailability information from a non-AP station. Additionally, BSRP trigger frame is used by an AP to solicit Buffer Status Report (BSR) from one or more non-AP station. BSRP can be aggregated with Control, Management, Data Frames if it is supported by the non-AP station.

Further in an embodiment, when the conditions under which an AP or a Mobile-AP can use BSRP to indicate unavailability which is different from existing art for a non-AP station and AP because when an AP or a Mobile-AP experiences IDC event, it needs to inform all the STAs in its Basic Service Set (BSS). Hence, the conditions according to the disclosure include, a DUO AP or a Mobile-AP STA operating in DUO Mode which is a TXOP holder that indicates in a BSRP Trigger frame whether the AP or a Mobile-AP will be unavailable after a specific point in time, and, if known, and for how long it is unavailable, by including a special user information field that contains an unavailability target start time (if known) which is either in current TXOP or beyond current TXOP and unavailability duration (if known). The DUO AP or Mobile-AP may transmit this BSRP Trigger frame when it knows the unavailability information (either start time, duration or both) and has any of the following conditions met:

DUO AP or Mobile-AP has Downlink buffered data for any of its associated non-AP station.

DUO AP or Mobile-AP has Buffer Status Report indicating pending Uplink Data from any of its associated non-AP station.

DUO AP or Mobile-AP has any Downlink Control, Management frames to send.

In one aspect of the existing technology, the Trigger Frame format, such as the Buffer Status Report Poll (BSRP) Trigger Frame, is defined according to the baseline specifications. An illustration of this frame format is provided in the known art, as referenced in Tables 1-6 of the following detailed description. The frame format when single Network Allocation Vector (NAV) protection settings apply, the BSRP TF carrying unavailability information or soliciting unavailability information sets the Duration/ID field to the time required to transmit the solicited HE/EHT/UHR TB PPDU plus one Short Inter-Frame space (SIFS) or if it is solicits non-HT (duplicate) PPDU, then the duration/ID field is set to match the length of the non-HT PPDU plus one SIFS. However, according to the disclosure, when an AP or a Mobile-AP sets BSRP-TF for multiple protection settings, it is set the following way:

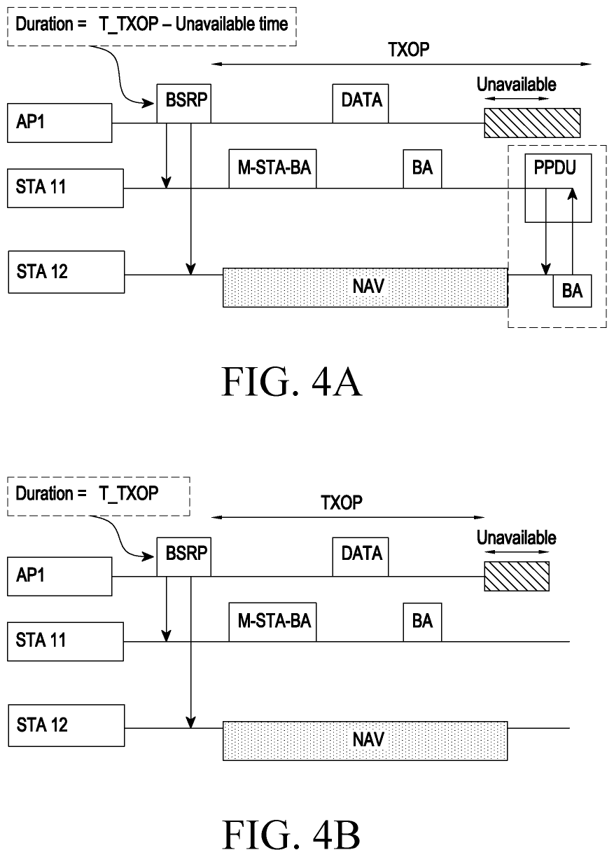

If Unavailability Start time is within TTXOP (as illustrated in FIG. 4A). Particularly, FIG. 4A illustrates a scenario when the unavailability start time is within TTXOP according to an embodiment of the disclosure.

Duration D=TTXOP−(Unavailability Duration).
where TTXOP=is the duration of TXOP for that Access Category.

Else legacy baseline to set the duration is followed as illustrated in FIG. 4B according to current prior art solutions. Particularly, FIG. 4B illustrates a scenario when the unavailability Start time is not within TTXOP according to an embodiment of the disclosure.

Thus, the advantage of setting duration value to only available time, allows all associated STAs to understand that the medium is not occupied and the STAs can engage in Peer-to-Peer transmissions if required where an AP or a Mobile-AP involvement is not required.

In some embodiments, the receiver address (RA) for any BSRP-TF that carries unavailability information from an AP or a Mobile-AP is sent as a broadcast address because all the associated UHR STAs are aware of an AP or a Mobile-AP unavailability.

Yet in another embodiment, the RA field is set as follows, For trigger frames which are not a GCR MU-BAR, NFRP, MU-RTS Trigger frame or BSRP Trigger Frame not carrying feedback (for example, unavailability information), and that has one user information field and the AID 12 subfield of the user information field containing the AID of a non-AP station, the RA field is set to the address of that STA. In one embodiment of the solution, for a trigger frame which is a BSRP Trigger Frame carrying unavailability information, and that has one user information field and the AID 12 subfield of the user information field containing the AID of a non-AP station, the RA field is set to broadcast address. In another embodiment of the solution, for a trigger frame that is a BSRP Trigger frame carrying unavailability information generating from an AP or a Mobile-AP, the RA field is set to a broadcast address. For a trigger frame that is a BSRP Trigger Frame carrying unavailability information from a non-AP station, the RA field is set to the address of the AP.

Table 2A represents the modified Table 2 as illustrated in subsequent detailed description. Table 2A is a scenario, of a UHR variant common information field format modified to contain Update Flag for the purposes of disclosure.

In an embodiment, GE And HE/UHR-LTF Type/TXS Mode Type subfield is set to 3 in an individually addressed BSRP Trigger frame, then the PPDU sent in response to the BSRP Trigger frame which is a non-HT (duplicate) PPDU that contains a M-STA-BA. Further, for an AP or a Mobile-AP, an additional condition is added that “If the GI And HE/UHR-LTF Type subfield is set to 3 in a broadcast addressed BSRP Trigger frame sent by an AP or a Mobile-AP containing unavailability information, then the PPDU sent in response to the BSRP Trigger frame is a non-HT (duplicate) PPDU that contains a M-STA-BA. Thus, the response is sent by the non-AP station addressed by the AID 12 field of the User-Info field.” Additionally, a Bit 22 is defined for an AP or a Mobile-AP, where the ICF can indicate that the unavailability feedback present is an update from previous broadcast frame containing unavailability. The Bit 22 is an “Update flag” when set to 1, indicates that the unavailability contained in the frame is an update from previous broadcast frame by the AP or Mobile-AP. Otherwise it is set to 0. For a non-AP station, it is set to 0 or follow baseline rules.

Further, some contributions according to existing arts in the task group for IEEE 802.11bn (Tgbn) task group are discussing to include a special AID 12 value from the reserved set of values to indicate unavailability indication when a BSRP is sent by a non-AP station. The design is made common for both an AP or a Mobile-AP and non-AP station so that it can include the special AID 12 value (for example, 2008) to indicate the presence of feedback (for example Unavailability Information) according to disclosure. In view of the above-mentioned changes, the following aspects are disclosed in the disclosure to be included as part of the specification:
AID 12 subfield encoding as illustrated in Table 1A (as shown below) and updates
Specify location of AID 12 in the trigger frame
Define Length of Special User Info field

TABLE 1A

| \|AID 12 | |
|---|---|
| sub field | Description |
| 0 | User Info field allocates one or more contiguous RA-RUs |
| | for associated STAs |
| 1-2007 | User Info field is addressed to an associated STA whose |
| | AID is equal to the value in the AID12 subfield |
| 2008 | Special/Feedback AID12 field that carries feedback (e.g. |
| | Unavailability) by either non-AP STA or Mobile-AP |
| 2009-2044 | Reserved |
| 2045 | User Info field allocates one or more contiguous RA-RUs |
| | for unassociated STAs |
| 2046 | Unallocated RU |
| 2047-4094 | Reserved |
| 4095 | Disallowed in a User Info field as it indicates the start |
| | of the Padding field |

Table 3A represents the modified Table 3 including a frame format for Special User Info field (or a Feedback User Info field) with AID 12 of 2008, in accordance with an embodiment of this disclosure. The length of the feedback provides total length of the information for the specific feedback type indicated in Bit 12 to Bit 15. The special user information field is a user info field that carries either extended common information when AID 12 value is 2007 or carries specific feedback information (for example, unavailability information) when AID 12 value is 2008. The special user information field (or feedback user information field) is identified by an AID 12 value of 2008 and is optionally present in a trigger frame that is generated by a UHR AP or a UHR non-AP station. The special user information field with AID 12 (or a feedback user information field) of 2008, if present, is located immediately after the special user information field of AID 12 2007, if present, immediately after common information field of the Trigger frame and carries feedback information specified by the feedback type. Further, the design of special user info feedback can be extended to other types of feedback apart from unavailability information. The name of special user information field is also alternatively called Feedback User Information field.

In the existing art, a non-AP station can send BSRP ICF with GE And HE/UHR-LTF Type/TXS Mode value set to 3 to indicate unavailability information to a DUO Assisting AP. The response is a M-STA-BA frame in non-HT (duplicate) PPDU format which is captured as: “The DUO non-AP station transmits the BSRP Trigger frame only if certain conditions are true. The response frame to such BSRP Trigger frames is a M-STA-BA frame in non-HT (duplicate) PPDU format.” Further, the BSRP-GI3 version of ICF is only sent under certain conditions and some prior art disclose conditions like when there is Uplink buffer or data to send and up to a threshold count of value. However, when an AP or a Mobile-AP unavailability is defined, a DUO assisting non-AP station can solicit unavailability information from the AP or a Mobile-AP just before a TXOP. Therefore, additional changes are required for the conditions under which a DUO Assisting non-AP station is sent, a BSRP-GI3 based Trigger frame. Hence, when an AP or a Mobile-AP is operating in DUO Mode, a non-AP station as a TXOP holder sends a BSRP-GI3 trigger frame to solicit unavailability information from the AP or a Mobile-AP in a M-STA-BA frame.

In an embodiment, a BSRP-GI3 Trigger frame that solicits unavailability information from an AP or a Mobile-AP, sets the Duration/ID field to 0. When the Duration/ID field is set to 0, NAV is not set on other devices, and they can listen to the multi-STA BA from an AP or a Mobile-AP that includes the unavailability information. Additionally, the BSRP-GI3 carrying the duration information required for the Access category (AC) for which data is pending on the non-AP station, the AP uses it to set the duration field in subsequent response. In another embodiment, set the Duration/ID field to include SIFS+Response time for multi-STA BA and follow baseline rules.

Further, in an embodiment, for the CS required, if the duration/ID field is set to 0, CS required field must be set to 0 as the AP or Mobile-AP needs to sense the medium before sending response.

In some embodiments, when the Duration/ID field is set to 0, then the BSRP GI3 TF also carries the intended duration of the data transmission following the ICF-ICR exchange. Table 3B, represents the modified Table 3 including an ICR-Duration which introduced in the BSRP Special or feedback user info field, in accordance with an embodiment of this disclosure. The ICR duration is carried as part of the feedback/special user information field as illustrated. The ICR-duration field of 2 octets carries time in microseconds. The ICR-duration field value is used by an AP or a Mobile-AP in setting the duration value of the ICR containing unavailability information.

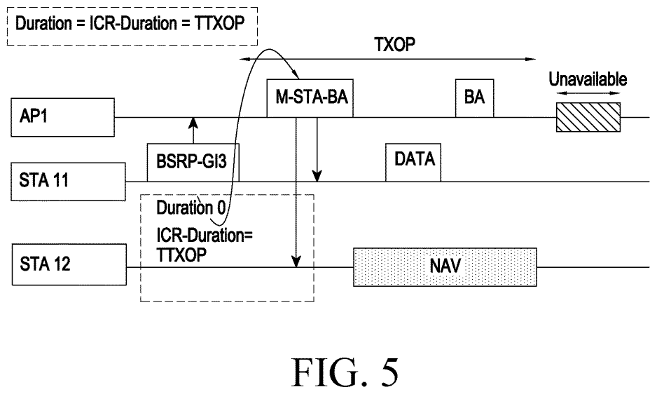

FIG. 5 illustrates the message sequence and how the M-STA-BA duration value can be set using the format as shown in Table 3B, according to an embodiment of the disclosure. In this illustration, an AP or a Mobile-AP has two non-AP station in its BSS. Non-AP STA acquires the medium and send a BSRP-GI3 trigger frame as an ICF being the TXOP holder. The duration is set to 0, to prevent NAV setting on other non-AP station, so that they can listen to the broadcast ICR from an AP or a Mobile-AP and then set NAV. The BSRP-GI3 ICF carries the ICR duration which is used to set the Duration/Id of the ICR that indicates the actual time of transmission required for ICR transmission+remaining time to transmit data per TXOP limit of the AC category of the data requesting transmission. The AP or Mobile-AP is in DUO mode and hence responds back with M-STA-BA whose Duration/ID is set as per above guide. The other non-AP station shall now use this to set its NAV and also update the unavailability information from the mobile-AP.

In an embodiment, the ICR design (Frame format design of ICR). M-STA BA frame format according to existing art as shown in 4, 5, 6A, 6B, 6C, 6D represents that the BA Control has BA Type set to M-STA BA, BA information has Per AID TID Info. Where the Per AID TID Info has AID TID Info (Which has AID 11, Ack Type, TID), BA Starting Sequence control (which has a fragment number and starting sequence and BA Bitmap.

In an embodiment, the AP or Mobile AP unavailability, ICR design is further defined as the M-STA-BA is the ICR which carries the unavailability information by a non-AP station as per agreed motions in 802.11bn task group. Similarly, the AP or Mobile-AP also sends M-STA-BA message as a response to BSRP-GI3 trigger frame that contains non-AP stations unavailability information. The function of M-STA-BA is hence two-fold and the design of the frame format needs to consider the two aspects. One is to a non-AP station; it acts as an acknowledgement of the BSRP-GI3 Trigger frame that contains the unavailability information of the non-AP station. And second aspect, to an AP or a Mobile-AP, the M-STA-BA carries the unavailability information of the AP or Mobile-AP as well. Thus, the following changes are additionally required to carry the unavailability information and an acknowledgement from the perspective of an AP or a Mobile-AP. For example, Duration is the value of duration is adjusted to reflect available time within a TXOP if unavailability falls within TXOP, else it can follow baseline rules. Modification to Receiver Address, indication of presence of Block Ack, Feedback indication (i.e., unavailability), Acknowledgement of BSRP with unavailability. Indication that the unavailability information has an update from previous broadcast in Beacon or unsolicited announcement.

In an embodiment, the Mobile AP unavailability, ICR design at Receiver address is modified. Further, according to existing art, the receiver address for a M-STA-BA is set as follows which needs to be modified to include the aspect that an AP or a Mobile-AP needs to inform its unavailability feedback to all its STAs. A High Efficiency (HE) AP that sends a M-STA-BA frame where the Per AID TID Info fields are addressed to more than one STA, sets the RA field to the broadcast address. The HE AP that sends a M-STA-BA frame where the Per AID TID Info fields are all addressed to a single recipient STA is sent in response to an HE TB PPDU, sets the RA field of the M-STA-BA frame to either the address of the recipient STA or to the broadcast address. The HE AP sends a M-STA-BA frame with the Per AID TID Info fields all addressed to a single recipient STA is not sent in response to an HE TB PPDU, sets the RA field of the M-STA-BA frame to the address of the recipient STA. Further, the non-AP HE STA sets the RA field to the TA field of the soliciting frame or to the address of the recipient. Thus, the Data or management frames of STA are acknowledged.

According to some embodiments of disclosure, the following modifications are considered with respect to the new mechanisms defined around the usage of M-STA-BA:

A DUO AP or a Mobile-AP sends a M-STA-BA frame where the Per AID TID Info fields contain special AID 11 value (for example, 2008) that carries feedback information for multiple STA in its BSS sets the RA field to the broadcast address.

A DUO AP or a Mobile-AP sends a M-STA-BA frame where the Per AID TID Info fields are all addressed to a single recipient STA and that is sent in response to an HE TB PPDU and includes special AID 11 value (for example, 2008) to carry feedback sets the RA field of the M-STA-BA frame to broadcast address.

A DUO AP or a Mobile-AP sends a M-STA-BA frame where the Per AID TID Info fields are all addressed to a single recipient STA and carries a special AID 11 value (eg. 2008) for carrying feedback which is not sent in response to an HE TB PPDU sets the RA field of the M-STA-BA frame to the address of the recipient STA.

According to some embodiments of disclosure, the following modifications are considered with the AP or Mobile AP unavailability with Special indicators. The M-STA-BA has following functions according to existing arts:

Carry BlockAck related information.
Act as an ACK to the Initial Control frame (for example, BSRP)
Carry unavailability information/feedback information

Hence, the disclosure proposes on adding method(s) to indicate the purpose of M-STA-BA and have special indicators indicating what information is being carried by the M-STA-BA. The methods include to indicate using BA Control field Indicate, using BA Information field.

Table 5A, represents the modified Table 5 including the BA Control field, in accordance with an embodiment of this disclosure. The BA Control field includes adding 2-bit indicator “Indication-flag” at Bit B5 and B6 to indicate whether the M-STA-BA is a simple acknowledgement and contains additional special feedback or simply acts as an ack to an ICF. The encoding of B5 and B6 is as shown in Table 7. B7 indicates an update flag that indicates that when it is set to 1, it indicates that there is an update to the unavailability times from previous broadcast information. The reserved values are used to indicate further information. Further, it is ensured that the receiver does not need to look for per AID TID info to understand all types of information and can prepare its decoder buffers accordingly.

According to another alternative embodiment, the Ack Type 1 and TID value of 13 is used to indicate that it is ICR context indicating an Ack to the ICF and no special feedback is present in the message. Ack Type 0 and TID value 13 is already defined according to the baseline existing arts. Further, the baseline rules apply to include M-STA-BA related information. Thus, the proposed changes according to the disclosure are shown in Table 8.

In an alternative embodiment, Update Flag in BA control can still be used to indicate that there is an update to the previously updated unavailability information. Unavailability information in response to M-PDU transmission. The M-STA-BA is originally used to carry block ack bitmap of the TB PPDUs. The M-STA-BA as an ICR carries unavailability information according to passed motions when it is a TXOP responder and by a non-AP station specifically. However, the M-STA-BA can be sent by an AP or STA in response to the data packets sent to indicate the block ack. This opens an opportunity to include the unavailability information in a regular M-STA BA that is not an ICR. According to the frame format as explained in above paragraphs, there is a requirement for corresponding modifications to specifications that enables a regular M-STA-BA to carry unavailability of feedback information from both non-AP station and an AP or a Mobile-AP that supports DUO. Thus, the M-STA-BA carries unavailability information: When a DUO non-AP station is operating in the DUO mode, then the DUO non-AP station indicates in a M-STA-BA which is generated in the context of an acknowledgement procedure, unavailability information using a special AID 11 value in the per AID TID info that indicates unavailability report including start time and duration if known.

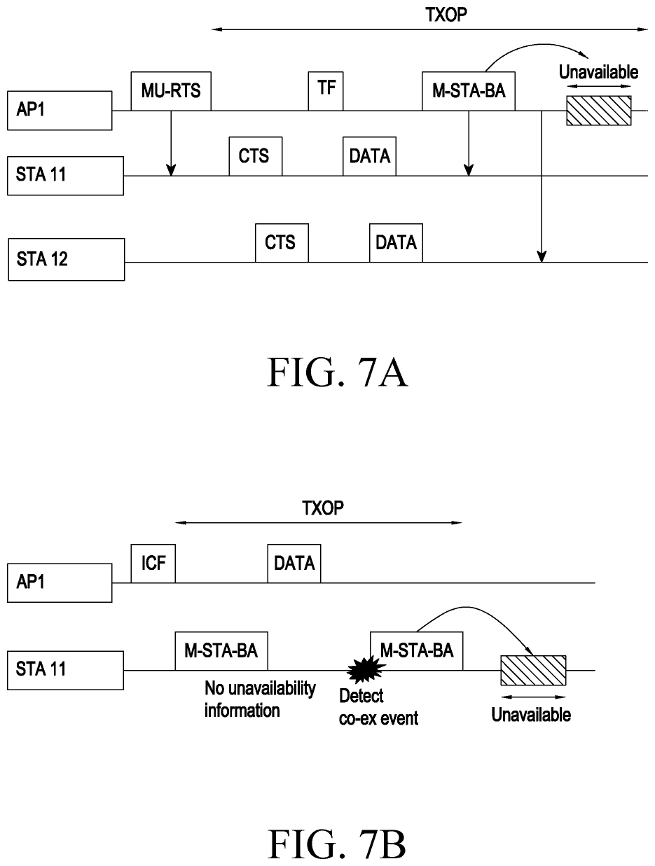

FIGS. 7A and 7B illustrate scenarios of a DUO AP and a DUO non-AP station operating in the DUO mode, according to various embodiments of the disclosure. The solution as illustrated in FIG. 7A, indicates that when a DUO AP is operating in the DUO Mode, then the DUO AP can indicate in a M-STA-BA that is generated in the context of an acknowledgement procedure (26.4.2), unavailability information using a special AID 11 value in the per AID TID info field that indicates the unavailability report including start time and duration if known. Additionally, the solution as illustrated in FIG. 7B, indicated that even if a DUO non-AP station is required to start a data exchange with an ICF-ICR exchange, it may not have unavailability information yet at the start of a TXOP. However, when there is opportunity to send M-STA-BA, it includes the unavailability information of which it now has the report.

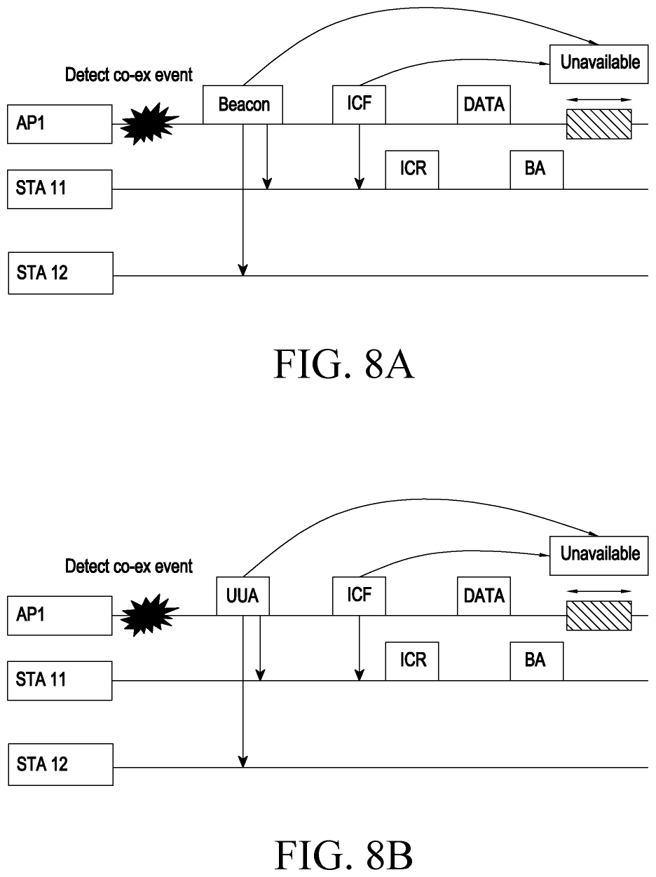

FIG. 8A illustrates a Beacon sending broadcast information that carries feedback of unavailability followed by an ICF-ICR frame exchange, according to an embodiment of the disclosure. FIG. 8B illustrates an unsolicited unavailability announcement frame (e.g. action frame) can be sent to achieve the same, according to an embodiment of the disclosure. The broadcast frame can be a management frame like Beacon or an Action frame which can be an unsolicited announcement to all the STAs in the AP or a Mobile-AP's BSS. Further, a feedback Element is defined which is included in the broadcast management frames to indicate the unavailability report or it can be part of UHR Operation Element:
Option 1: New Element ID is defined for Feedback Information
Option 2: Defined as part of UHR Operation Element

In some embodiments, new elements definition is described in Table 9 to Table 11 as given below. In some embodiments, feedback Information with the DUO an AP or a Mobile-AP uses the Feedback Information element to indicate the unavailability information in unsolicited announcement in a Beacon/Association Response/Probe Response and the like. Beacon, Association Response, probe response etc., includes the element feedback information element when the AP or the Mobile-AP needs to indicate the unavailability report and information.

In some embodiments, UHR operation element is defined by including a feedback information element indicates whether the feedback for unavailability information is present as per below which is added to the existing UHR operation parameters element as explained in the current version of specification of 802.11bn.

Further, the UHR operation element can include feedback information present. When feedback information is present or set to 1, it can indicate the type of feedback, and when the type of feedback is unavailability or Co-Ex, and indicate the unavailability start time and duration. The encoding of feedback type is set as 01 for unavailability and the rest of the values are reserved for future use.

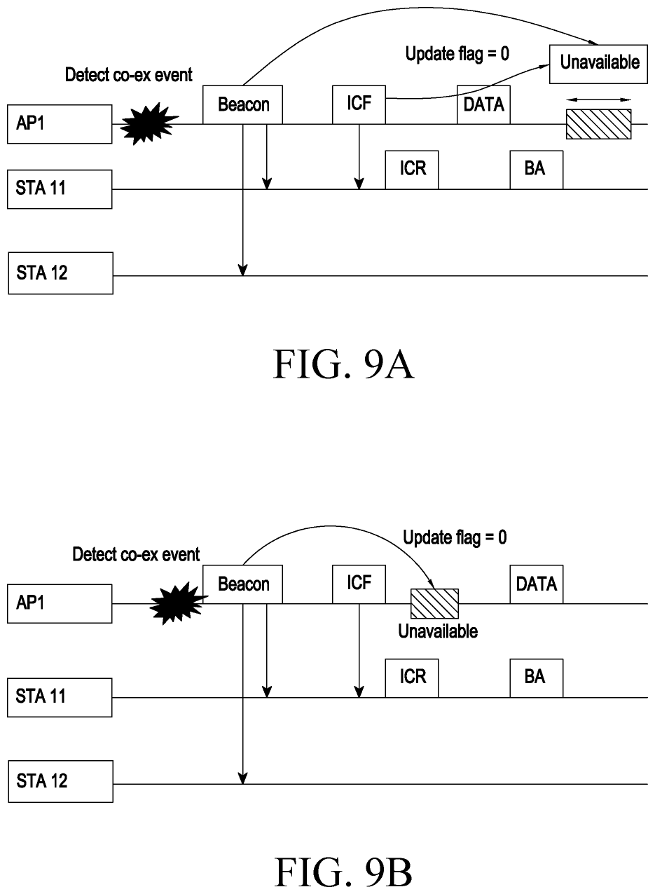

FIGS. 9A and 9B illustrate unavailability report handling at non-AP station, according to various embodiments of this disclosure. The mobile-AP indicates its unavailability information through broadcast messages like Beacon, ICF-ICR and so on so that all non-AP stations are able to listen to the unavailability times at AP. However, in current baseline, the AP is allowed to process only one unavailability report from non-AP station but cannot continue having same analogy for a non-AP station to process the Mobile-Aps unavailability reports. Hence, the AP or a Mobile-AP uses the update flag in ICF-ICR to indicate if there is an update to the unavailability report from previous broadcast in a management frame like unannounced unavailability report or Beacon frame etc. Further, using the update flag, if the non-AP station processes that there is an update, it shall read the full unavailability report, else it will ignore the update. The non-AP station does not listen to previous broadcast for some reason, will ignore the update flag and read the full unavailability report.

The disclosure enables IDC design with enhanced unavailability information which is sent by the AP or a Mobile-AP.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The term “device”, “communication device”, “wireless device”, “apparatus” and or any other variations thereof, are intended to cover a single meaning and may be interchanged used in the disclosure.

In an embodiment, the disclosure provides a method for indicating unavailability information in a Wi-Fi system, comprising determining by the AP, a dynamic unavailability time information for a period when the AP is unable to utilize a duration of transmission opportunity, the dynamic unavailability time information comprises at least one of a start time of unavailability time slot and a duration of unavailability and indicating, by the AP, the dynamic unavailability time information in a control frame. The method further comprises transmitting by the AP, the control frame to at least one non-AP station in the Wi-Fi system.

Yet in an embodiment, an access point (AP) indicating its unavailability in a Wi-Fi system. The AP comprising a processor and memory coupled to the processor, a wireless transceiver configured to communicate with at least one external device, wherein the processor is configured to determine a dynamic unavailability time information for a period when the AP is unable to utilize a duration of transmission opportunity, the dynamic unavailability time information comprises at least one of a start time of unavailability time slot and a duration of unavailability, and to indicate the dynamic unavailability time information in a control frame. The processor is further configured to transmit the control frame to the at least one external device, the external device being a non-AP station in the Wi-Fi system.

In another embodiment, the disclosure provides a method for indicating unavailability information in a Wi-Fi system, comprising determining by the non-AP station, a dynamic unavailability time information for a period when the AP is unable to utilize a duration of transmission opportunity, the dynamic unavailability time information comprises at least one of a start time of unavailability time slot and a duration of unavailability and indicating by the non-AP station, the dynamic unavailability time information in a control frame. The method further comprises transmitting by the non-AP station, the control frame to at least one AP in the Wi-Fi system.

Yet in another embodiment, a non-access point (AP) station indicating its unavailability in a Wi-Fi system. The non-AP station comprising a processor, memory coupled to the processor, a wireless transceiver configured to communicate with at least one external device, wherein the processor is configured to determine a dynamic unavailability time information for a period when the non-AP station is unable to utilize a duration of transmission opportunity, the dynamic unavailability time information comprises at least one of a start time of unavailability time slot and a duration of unavailability, and to indicate the dynamic unavailability time information in a control frame. The processor is further configured to transmit the control frame to the at least one external device, the external device being an AP station in the Wi-Fi system.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

In an embodiment the disclosure provides method and apparatus for indicating unavailability information in a Wi-Fi system.

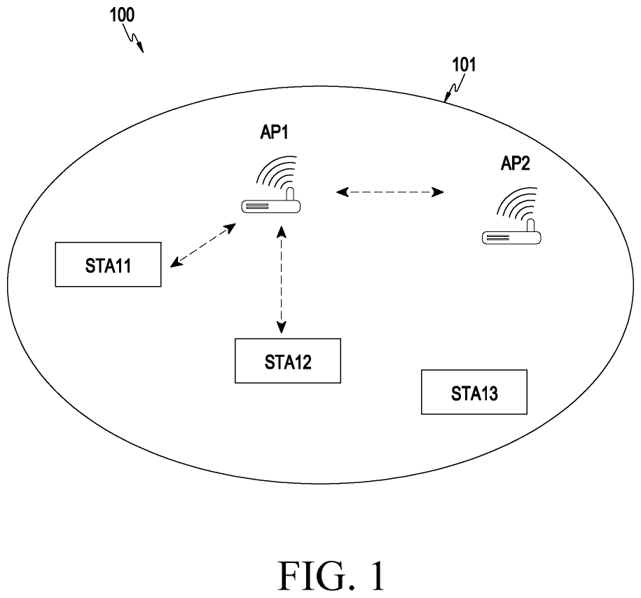

FIG. 1 illustrates an environment of a Wi-Fi network for indicating unavailability information, according to an embodiment of the disclosure.

In an embodiment, a non-limiting environment 100 may comprise one 802.11 Wi-Fi network with a system 101. The Wi-Fi network is compatible with an IEEE 802.11 a/b/g/n protocol. For example, the Wi-Fi network 100 environment may be compatible with IEEE 802.11 such as IEEE 802.11ac, IEEE 802.11ax, IEEE 802.11be, and IEEE 802.11bn and future IEEE 802.11 amendments as applicable. IEEE 802.11ac is referred to as a very high throughput (VHT). IEEE 802.11ax is referred to as high efficiency (HE). IEEE 802.11be is referred to as extremely high throughput (EHT). IEEE 802.11bn is referred to as ultra-high reliability (UHR). The Wi-Fi network may be used in various applications, such as in large industries, homes, offices and or enterprise applications. Although the systems included in Wi-Fi network 100 as shown in FIG. 1 with certain components and described with certain functionality herein, other embodiments of the Wi-Fi network and related systems may include fewer or more components to implement the same, less, or more functionality. For example, in some embodiments, the Wi-Fi network may include ‘n’ number of systems and non-limiting to the systems 101 as shown in figure, whereas ‘n’ may be any number. Further, the ‘n’ number of systems may include multiple access points (Aps) with multiple stations (STAs), one AP with one STA, or one AP with multiple STAs. Further, the APs may be a static AP or a non-static AP also known as mobile-AP or soft-AP. For example, communication devices such as wireless routers and hotspot devices also support Wi-Fi APs capabilities.

In an embodiment, the system 101 may comprise of wireless devices such as Access Point (AP), AP1 and AP2, station (STA) STA11, STA12 STA13. The number of STAs such as STA11, STA 12, STA13 associated with the respective AP1 and AP2 (not shown here) maybe different from one another. The access points (AP1 and AP2) may communicate with peer-to-peer (P2P) mode, or as the Internet, a proprietary Internet Protocol (IP) network, or other data network.

In this disclosure, in non-limiting embodiments APs may be implemented as mobile-APs or non-static APs. APs or the Mobile-APs may support wireless communication technologies such as, Bluetooth (BT) and/or BT low energy (BTLE) to allow for communication with other devices that support BT and/or BTLE. In addition, these mobile-APs may support cellular communications such as, a cellular data connection such as third generation (3G), fourth generation (4G), fifth generation (5G), sixth generation (6G) or other data communication standard. The mobile-APs may also support tethering capabilities for sharing a cellular data connection with other communication devices over, a WLAN for Wi-Fi communications, a personal area network (PAN) for BT and/or BTLE communications, and/or other wireless connections. The tethering service can be capable of providing software enabled access point (AP) services as a “soft” access point (Soft-AP). In such a configuration, the mobile-AP supporting Soft-AP may provide data communications over a WLAN connection to other wireless or wired client stations (STAs). The hardware and software configurations may differ between the static AP and non-static AP, however, the methods described in the disclosure can be implemented for both types of APs. Furthermore, the APs communicate through single communication link, and in some embodiments, the APs may be affiliated with an AP in Multiple Access Point (MAP). For example, the system 101 as shown in figure as included with one AP1 as mobile-AP1 and another AP2 as mobile-AP2 respectively, other embodiment, may include multiple APs. In these embodiments, each of APs in the respective systems may operate in same or different frequency band or bandwidth. In non-limiting example, mobile-AP may operate in a 2.4 gigahertz (GHz) frequency band for one service, such as Bluetooth. APs or the Mobile-APs may operate in a 2.4 GHz-5 GHz frequency band for another service such as Wi-Fi. APs or the Mobile-APs may also incorporate support for millimeter wave (mmWave) frequencies for another service. APs or the Mobile-APs may operate in a 600 MHz-3.5 GHz or more frequency band for another service such as cellular services. In some embodiments, two mobile-APs mobile-AP1 and mobile-AP2 may operate in different channel within a frequency band.

Further in an embodiment, the mobile-AP1 and mobile-AP2 may provide access to frequency channels for communication to each other using Wi-Fi network 100. In some embodiments, two APs may operate in same or different channel within a frequency band. The mobile-APs may correspond to a mobile device, a communication device, a cellular telephone, a laptop, a hotspot device and or devices with similar capabilities.

Further, in an embodiment, the term “APs” or “access point” or “mobile-AP” is used interchangeably in this disclosure to refer to network infrastructure components that provide wireless access to remote terminals. In an embodiment, the APs may comprise, be implemented as, or known as a Node B, Base Station Controller (BSC), Base Transceiver Station (BTS), Base Station (BS), Transceiver Function (TF), Radio Router, Radio Transceiver, wireless transceiver, Basic Service Set (BSS), Extended Service Set (ESS), Radio Base Station (RBS), or some other terminology. It can be a standalone product or it may be integrated in a device, for instance in a broadband remote access server (BRAS). In an embodiment, one or more of the APs may include circuitry and/or programming for management of MU-MIMO and OFDMA channel sounding in WLANs. In an embodiment, all the APs such as AP1 and AP2 may be communicably connected in a Multi AP configuration and may include affiliated multiple APs not shown here. Each affiliated multiple APs may include a PHY interface to wireless medium by which the APs such as AP1 and AP2 are connected to the associated STAs in the system 101. The affiliated multiple APs may include a single medium access control (MAC) service access point (SAP) through which the affiliated APs may communicate with a higher layer such as network layer. Each affiliated AP may have a MAC address (lower MAC address) different from any other affiliated APs. The affiliated APs may have a MAC address (upper MAC address) and the affiliated APs share the single MAC SAP to the network layer in the Wi-Fi network. Thus, the affiliated APs share a single IP address, and network layer may recognize the affiliated APs by assigning the single IP address.

In an embodiment, the terms “station” and “STA” are used interchangeably in this disclosure to refer to remote wireless equipment that wirelessly accesses the APs or contends for a wireless channel in a WLAN. The STAs may be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, STAs may be or may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem to access the internet services. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, internet of things (IOT) devices or any other suitable device that is configured to communicate via a wireless or wired medium. In some aspects, STAs may be a wireless node. Such a wireless node may provide, for example, connectivity for or to a network (e.g., a wide area network such as the Internet or a cellular network) via a wired or wireless communication link.

The term ‘STAs’ may be used interchangeably throughout the disclosure to refer to devices such as STA11, STA12, and STA13 and to ‘non-AP stations (STA)’.

In an embodiment, the APs manages the set of STAs that together organize their accesses to the wireless medium known as ‘operating channel’ for communication purposes. Further the STAs and their associated APs are referred to as Basic Service Set (BSS), throughout the disclosure. In an embodiment, the system 101 represents the BSS, as shown in the related figure. The BSS is defined by an association process of IEEE 802.11 and is a network topology which includes an APs and one or more STAs associated with the APs. For example, mobile-AP1 and its associated STA11, STA12, STA13 and AP2, may be considered as the BSS, utilizing an operating channel. STA11 and STA12 are connected to AP1, whereas STA13 is neither connected nor utilizing wireless services from any AP. Furthermore, AP1 and AP2 may be interconnected via a point-to-point (P2P) link. The accompanying figure illustrates this scenario solely for explanatory purposes and should not be construed as limiting. A physical station acting as an access point may be employed to manage two or more BSS (and thus corresponding WLANs) each BSS is thus uniquely identified by a specific Basic Service Set Identification (BSSID) and managed by a separate virtual AP implemented in the physical AP (Not shown here).

The number of STAs as shown in figure is merely provided for illustrative purposes and may be any number of STAs in a single BSS. The APs, STAs and associated components and functions described herein may be implemented with hardware circuitry such as one or more of analog circuitry, mix signal circuitry, memory circuitry, logic circuitry, and processing circuitry that executes code stored in memory that when executed by the processing circuitry performs the disclosed functions and or including software, firmware or combination thereof.

The term “BSS” may be used interchangeably used to refer the system 101 throughout this disclosure.

Now, addressing the general aspect of the disclosure, the objective is to assist a person skilled in the art in integrating prior knowledge to effectively implement the disclosure.

In non-limiting embodiment, and in a general aspect, smartphones often act as mobile-APs (for example, mobile-AP1) or Soft-AP, allowing users (here STA11 and STA12) to share Wi-Fi while simultaneously running other wireless technologies like Bluetooth, UWB, cellular (4G/5G/6G), or Wi-Fi Direct (P2P). Since many of these technologies operate on similar frequencies and share radio resources, conflicts can occur when the mobile-AP is busy with another task, causing the mobile-APs to become temporarily unavailable. These interruptions, called Co-existence events, lead to In-Device Coexistence (IDC) issues, such as higher power consumption and reduced data rates for both the mobile-APs and connected devices (STAs). DUO mode can be periodic (predictable and signaled in advance) or aperiodic (sudden and signaled at transmission time). Managing these events efficiently is crucial to maintain reliable connectivity and energy efficiency.

This aspect further explains in the IEEE 802.11 Ultra High Reliability (UHR) Task Group where in the 802.11bn standard, which introduces mechanisms to handle IDC issues, situations where a mobile-AP or AP temporarily becomes unavailable due to conflicts with other wireless technologies (like Bluetooth or P2P). To address this, a signaling method using Initial Control Frame (ICF) and Initial Control Response (ICR) has been defined. This allows an Access Point (AP) and non-AP stations (STAs) to exchange information about periods of unavailability. The STA can indicate when and for how long it will be unavailable, either proactively or in response to AP queries. This information helps optimize scheduling and reduce retransmissions, improving reliability and power efficiency. Devices that support this feature operate in dynamic unavailability operation (DUO) mode, enabling smarter coordination during coexistence events.

In a general aspect, signaling method as discussed in preceding paragraph may utilize the ICF as a frame format that may include a trigger Buffer Status Report Poll (BSRP) trigger frame and a BSRP non-trigger base (BSRP-NTB). The BSRP trigger frame is known and person skill in art may identify the fields as shown in tables below. Further, Table 1 represents the BSRP trigger frame. The common information field is modified in UHR specifications to include additional information like when Bit 20-21 value is set to 3, it shall solicit a non-HT duplicate PPDU as a response and is also known as BSRP-NTB as shown in Table 2.

TABLE 1

| | | | | | User | | |
|---|---|---|---|---|---|---|---|
| Frame | | | | Common | Info | | |
| Control | Duration | RA | TA | Info | List | Padding | FCS |
| Bits 2 | Bits 2 | Bits 6 | Bits 6 | Bits 8 | variable | variable | Bits 4 |
| | | | | or more | | | |

Table 2 below, represents the subfield, common info field of the BSRP trigger frame.

TABLE 2

| | | | | | GE And | | |
|---|---|---|---|---|---|---|---|
| | | | | | HE/UHR- | | Number of |
| Trigger | UL | More | CS | | LTF Type/ | | HE/UHR- |
| Type | Length | TF | Required | UL BW | TXS Mode | Reserved | LTF symbols |
| Bits 4 | Bits 12 | Bits 1 | Bits 1 | Bits 2 | Bits 2 | Bits 1 | Bits 3 |
| (B0-B3) | (B4-B15) | (B16) | (B17) | (B18-B19) | (B20-B21) | (B22) | (B23-B25) |

| | LPDC | | | | | | |
|---|---|---|---|---|---|---|---|
| | Extra | | Pre-FEC | PE | UL | | |
| | symbol | AP Tx | Padding | Disambi- | spatial | | HE/UHR |
| Reserved | segment | Power | factor | guity | Reuse | Reserved | P160 |
| Bits 1 | Bits 1 | Bits 6 | Bits 2 | Bits 1 | Bits 16 | Bits 1 | Bits 1 |
| (B26) | (B27) | (B28-B33) | (B34-B35) | (B36) | (B37-B52) | (B53) | (B54) |

| | | | | | Trigger |
|---|---|---|---|---|---|
| Special | | IFCS | | | Dependent |
| User Info | DRU/RRU | Present | UHR | | Common |
| Field Flag | Indication | Flag | Reserved | Reserved | Info |
| Bits 1 | Bits 4 | Bits 1 | Bits 2 | Bits 1 | Bits |
| (B55) | (B56-59) | (B60) | (B61-B62) | (B63) | variable |
| | | | | | variable |

Table 3 below, represents the subfield, user info list of the BSRP trigger frame.

TABLE 3

| | | UL | | | | UL | | |
|---|---|---|---|---|---|---|---|---|
| | | FEC | | | | Target | | Trigger |
| AID | RU | Coding | UL | 2*LD | SS | Receive | | dependent |
| 12 | Allocation | Type | UHR-MCS | PC | Allocation | Power | PS 160 | User Info |
| Bits 12 | Bits 8 | Bits 1 | Bits 5 | Bits 1 | Bits 5 | Bits 7 | Bits 1 | Variable |
| (B0-B11) | (B12-B19) | (B20) | (B21-B25) | (B26) | (B27-B31) | (B32-B38) | (B39) | |

The user info field as shown above also has provision for a special user info field identified by the AID 12 value.

In a general aspect, signaling method as discussed in preceding paragraph may also utilize the ICR as a frame format that may include a multi-station block acknowledgment (M-STA BA) frame format. The M-STA BA frame is known and person skill in art may identify the fields as shown in tables below. Further, Table 4 represents the M-STA BA frame.

TABLE 4

| Frame | | | | BA | BA | |
|---|---|---|---|---|---|---|
| Control | Duration | RA | TA | Control | Information | FCS |
| Bits 2 | Bits 2 | Bits 6 | Bits 6 | Bits 8 | Variable | Variable |
| | | | | or more | | |

Table 5 represents the subfield, BA control field of the M-STA BA frame.

TABLE 5

| | | | | Memory | | |
|---|---|---|---|---|---|---|
| | | | No | config- | | |
| | BA | | Memory | uration | Manage- | TID |
| Reserved | Type | Reserved | Kept | Flag | ment Ack | Info |
| Bits 1 | Bits 4 | Bits 4 | Bits 1 | Bits 1 | Bits 1 | Bits 4 |
| (B0) | (B1-B4) | (B5-B8) | (B9) | (B10) | (B11) | (B12-B15) |

Table 6 (A-D) represents the subfield, BA information of the M-STA BA frame.

TABLE 6A
Per AID TID info

Variable

TABLE 6B

| | Block Ack Starting | |
|---|---|---|
| AID TID Info | Sequence control | Block Ack Bitmap |
| Bits 2 | Bits 0 or 2 | Bits 0, 4, 8, 16, 32, 64 or 128 |

TABLE 6C

| AID 11 | Ack Type | TID |
|---|---|---|
| Bits 11 | Bits 1 | Bits 4 |
| (B0-B10) | (B11) | (B12-15) |

TABLE 6D

| Fragment Number (0) | Starting Sequence Number |
|---|---|
| Bits 4 | Bits 12 |
| (B0-B3) | (B4-B15) |

Building upon the above illustration and the general aspects of the disclosure, the disclosure is further elaborated in the subsequent figures.

The disclosure addresses scenarios in which system 101 manages and provides unavailability information, particularly when one or more APs are configured to mitigate IDC issues. It further defines the operation of the DUO mode for devices within system 101.

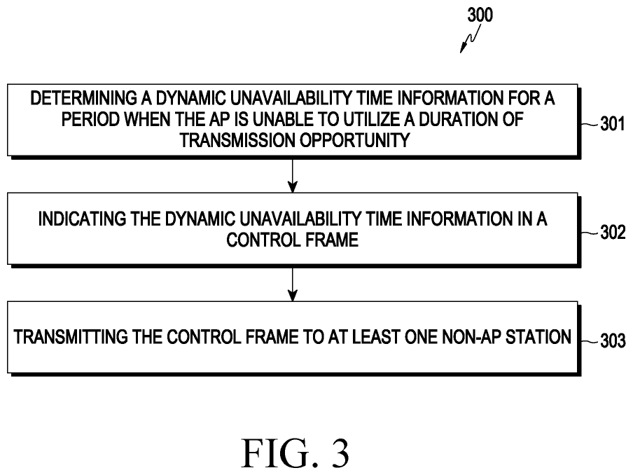

The detailed description of the present method is illustrated through the method operations depicted from FIG. 3 onwards, as outlined in the upcoming paragraphs. These operations collectively define the operational sequence of the disclosure and serve to clarify its functional aspects.

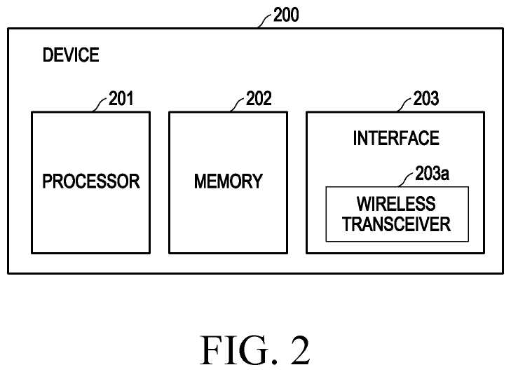

Before moving to the functional aspect of the disclosure, devices employing hardware configuration to implement the method operations are disclosed in the foregoing paragraphs in FIG. 2 description below.

FIG. 2 illustrates an example of hardware configuration of both APs and STAs, according to an embodiment of the disclosure.

In an embodiment, the communication device 200 may be a wireless device or device or may be an embodiment of the APs such as AP1, AP2 or multiple affiliated APs and or the STAs such as STA11, STA12, and STA13 or multiple STAs associated with the APs. In an embodiment, the communication device 200 may be implemented to execute the method operations for indicating unavailability information in a Wi-Fi network.

In an embodiment, the communication device 200 may include a processor 201. memory 202 and an interface 203. The processor 201, the memory 202 and interface 203 are communicably configured to execute the method operations disclosed in the disclosure. Further the communication device 200 may also include antennas, RF transmitter and RF receiver circuitry or transceiver circuitry, a microphone, speaker, input and output interface circuitry, touchscreen, display and or the like analog and digital circuitry employed or implemented to process the operations in the Wi-Fi network and the description of these is omitted here for the sake of brevity, as these components and related configuration is known to the person skill in the art. Furthermore, the hardware configuration of communication device 200 may be implemented with the components configured in the Wi-Fi network based on the IEEE 802.11 family of standards and or wi-fi protocols or standards.

In an embodiment, the processor 201 is embodied as an executor of software instructions stored. As such, the processor 201 is capable of executing the instructions stored in the memory 202 to perform one or more operations or method operations described herein. The processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a Digital Signal Processor (DSP), a processing circuitry with or without an accompanying DSP, or various other processing devices including, a microcontroller unit (MCU), a hardware accelerator, a special-purpose computer chip, or the like. The processor 201 may also be known as controller is also capable of executing other processes and programs resident in the memory 202, such as operations for management of procedures in WLANs. The processor 201 can move data into or out of the memory 202 as required by an executing process. Further the processor 201 may be divided into multiple processors, such as one or more central processing units (CPUs) and one or more graphics processing units (GPUs) or processors with distributed implementation of the processor 201, in different applications with same implemented method operations of the disclosure.

Further in an embodiment, the memory 202 may be a hardware component configured to store data related to operations, information or instructions performed by the processor 201. The memory 202 may store software codes which implements instructions that, when executed by the processor 201, perform the descriptions, functions, procedures, methods and/or operational flowcharts, sequence diagrams disclosed in the disclosure. In an aspect, the memory 202 may be a random-access memory (RAM), a dynamic RAM (DRAM), a read only memory (ROM), a flash memory, a volatile memory, a non-volatile memory, a memory card, a storage medium and/or other storage device and/or a combination thereof.

Further in an embodiment, the interface 203 may be a hardware component including one or more one or more wireless interfaces such as, a WLAN interface(s), a cellular network interface(s), a BT interface(s), and/or other components. The interface 203 may be configured to support wireless communication to wireless clients using Wi-Fi, Bluetooth, and/or other wireless technologies via the wireless interfaces such as wireless transceiver 203a. The WLAN interface(s) may correspond to one or more interface(s) which are configured to support Wi-Fi communications. In some embodiments, multiple WLAN interfaces may be present to support multiple WLAN networks, multiple basic service sets (BSS), etc. The cellular network interface(s) may correspond to one or more interfaces which are configured to provide access to a cellular network such as a 3G or 4G or 5G or 6G network, a worldwide interoperability for microwave access (WiMAX) network, and/or other types of networks. Further, the cellular network interface(s) can support high speed data transfer over the cellular network. The BT interfaces may correspond to one or more interface(s) which are configured to support BT and/or BTLE communications. The device 200 may also include other types of network interfaces such as, for example, Ethernet interfaces, universal serial bus (USB) network interfaces, token ring interfaces, and so on. In addition, the communication device 200 may be used for other activities such as, e.g., web browsing, gaming, and/or other user interactive applications.

Furthermore, in an embodiment, interface 203 can monitor wireless communication through wireless interfaces such as the WLAN interface(s), the cellular network interface(s), the BT interface(s), and/or other components to determine whether coordination of coexisting RF communications is needed to avoid interference. The determination may be based upon one or more factors such as, e.g., transmission frequencies, transmission powers, type of communication, etc., which may be received from the different wireless interfaces discussed above in preceding paragraph. For example, interference may be unlikely for specific combinations of wireless communications. When those defined conditions exist, the interface 203 may determine that coordination of the coexistent RF signals is not needed. In other instances, coordination of combinations of wireless communications may be desired because of the proximity of the operational frequencies of the RF signals. For example, the coexistence of a long term evolution (LTE) communication signal with WLAN, BT, and/or BTLE signals may result in mutual interference. LTE communications can occur in band 600 MHz-3.5 GHz and or band 7 (2500-2570 MHz and 2620-2690 MHz) or band 40 (2300-2400 MHz), which are both adjacent to the WLAN 2.4 GHz industrial, scientific and medical (ISM) band (2400-2500 MHz). If the frequency separation between the LTE and WLAN operating frequencies is sufficiently large, then simultaneous transmission and/or reception may be allowed without coordination of the LTE and WLAN communications.

FIG. 3 illustrates a flow chart illustrating a method 300 for indicating unavailability information by an AP in a Wi-Fi network, according to an embodiment of the disclosure.

The method 300 may comprise one or more operations. Further, the order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof. Furthermore, the components or devices are discussed in detail, taking reference from FIG. 3, therefore omitted here for the sake of brevity. Further the processor 201, the memory 202 and the interface 203 are configured to execute the method 300 operations discussed below.

In one embodiment, the method 300 operations described below may be executed when both the systems 101 utilize or manage unavailability information of the AP in Wi-Fi network. In the disclosure AP or APs may be interchangeably used for AP1 or AP2 or their combination.

Now getting in details of method 300 operations explaining the functional aspect of the disclosure, the device 200 is configured to perform the following operations:

At operation 301, method includes to determine a dynamic unavailability time information for a period when the AP is unable to utilize a duration of transmission opportunity by the APs, operating in a system 101. The dynamic unavailability time information comprises at least one of a start time of unavailability time slot and a duration of unavailability. The term ‘dynamic unavailability time information’ is interchangeably used as ‘unavailability events’ or as a ‘unavailability time information’ or as ‘unavailability information’ in the disclosure.

In operation 301, the determination process further includes monitoring, by the APs, their operational status and communication constraints within system 101. The determination also includes detecting unavailability events, such as identifying situations in which the AP is unable to utilize its assigned transmission opportunity, for example, due to mobility, interference like coexistence, scheduling conflicts, or resource reallocation. Upon detecting an unavailability event, the determination may further involve recording the start time by logging the exact moment when the AP becomes unable to transmit. Additionally, the determination may include calculating the duration by measuring how long the AP remains unable to utilize the transmission opportunity until normal operation resumes. Based on these observations, the method 301 further includes generating the dynamic unavailability time information by compiling the determined start time and/or duration into a structured dataset. Finally, the method 301 includes providing this information to system 101 and associated devices such as associated another APs (here AP2) and stations (STA11, STA12, STA13), enabling improved scheduling, resource allocation, and mobility management within the system 101 as discussed in upcoming paragraphs of the disclosure. In an embodiment, the AP1 determines its unavailability time information and further utilizes the unavailability time information to be shared with the associated or non-associated STAs (STA11, STA12, and STA13) and associated APs (AP2). However, the foregoing example is not intended to limit the scope of the disclosure with respect to the configuration of the AP1 or the selection of any specific APs within the system 101 and or outside the system 101 with other systems (not shown here) as well. The example is provided solely for illustrative purposes and should not be construed as restrictive.

Further, at method operation 302, based on the determining as depicted in operation 301, the determined unavailability time information is indicated in a control frame by the APs. For example, the unavailability time information is indicated in the control frame of the AP1. In the disclosure, the control frame may take the form of a BSRP initial control frame (BSRP ICF), a BSRP-NTB non-trigger based initial control frame (BSRP-NTB ICF), or a multi-station block acknowledgment initial control response (M-STA-BA ICR). The general characteristics are described in the preceding sections and the selection and behavior of these control frames is known to person skill in the art and therefore omitted for the sake of brevity. Within this disclosure, the BSRP-ICF and BSRP-NTB-ICF may be used interchangeably and are collectively referred to as a first control frame, while the M-STA-BA-ICR is used interchangeably as a second control frame. These definitions apply throughout this specification for the APs.

Further after method operation 301, the system 101 identifies conditions to initiate the method operation 302 to indicate the unavailability time information in the control frame of the AP1. In an embodiment, the AP initiates the transmission of a control frame after continuously monitoring various operational conditions within system 101. This initiation may occur when the AP detects that downlink buffered data for one or more STAs, indicating that data delivery from the APs to associated STAs is pending. Additionally, the AP may trigger the control frame when it either receives or identifies a request as a control frame such as BSRF-NTB that signals pending uplink data from any of the associated STAs or when AP receives buffer status report, indicating pending uplink data from APs associated non-AP station. Such a request notifies the AP that specific STAs require an uplink transmission opportunity. Furthermore, the initiation of the control frame may also take place when the AP determines that a downlink control or management frame is buffered and awaiting transmission. In all these non-limiting scenarios, the mobile-AP evaluates the communication context and the states of the system 101 to decide when to generate and transmit the appropriate control frame, thereby ensuring efficient coordination of both uplink and downlink communication activities.

In an embodiment, once the conditions required to initiate the control frame are identified, the method proceeds to operation 302, which involves determining whether the dynamic unavailability time or unavailability time obtained in operation 301 falls within the transmission opportunity (TXOP) duration. If the control frame operates under single-protection settings, and the frame is a BSRP Trigger Frame (TF) that either carries unavailability information or solicits such information, the Duration field is set to a value corresponding to the transmission time of the solicited HE/EHT/UHR TB PPDU plus one short inter-frame space (SIFS). If the BSRP TF solicits a non-HT (duplicate) PPDU, the Duration/ID field is set to match the duration of the non-HT PPDU plus one SIFS. In another embodiment, when the AP configures a BSRP-TF for multiple-protection settings, the Duration/ID field is determined based on the relationship between the unavailability interval and the TXOP duration. When the start time of the unavailability interval falls within the TXOP, as illustrated in FIG. 4A, the AP sets the Duration field in the BSRP ICF frame to a value as shown in equation 1:

$$D = T\_TXOP - ( Unavailability Start Time + Unavailablity Duration ) \qquad Equation 1$$

T_TXOP: represents the duration of the TXOP or TXOP duration for the associated access category.

Further in the embodiment, if the unavailability interval does not fall within the T_TXOP, the AP applies the legacy baseline rules for setting the Duration field. This approach enables associated STAs to recognize portions of the T_XOP during which the medium is available, allowing them to perform peer-to-peer transmissions (as shown in FIG. 4A) as needed. Accordingly, when the evaluation in operation 302 determines that the dynamic unavailability time information lies within the TXOP duration, the Duration field of the control frame is set to represent the portion of the TXOP extending up to the start of the unavailability interval, excluding the unavailability duration itself. Conversely, when the unavailability interval falls outside the TXOP duration, the Duration field of the control frame is set to represent the full duration of the TXOP as shown in FIG. 4B.

In an embodiment, when the start time of the unavailability interval falls within the TXOP, the BSRP-ICF or BSRP-NTB-ICF may set the receiver address (RA) field (refer Table 1) of the first control frame to a broadcast address. Using a broadcast address ensures that all associated STAs are made aware of the AP's unavailability. In the embodiment, two options are provided for trigger frames carrying unavailability information. In one embodiment, when the trigger frame is a BSRP Trigger Frame carrying unavailability information and contains a single User Info field whose AID 12 subfield carries the AID of any of the STAs, the RA field is set to a broadcast address. Further in an aspect, in another embodiment, when the Trigger frame is a BSRP Trigger Frame carrying unavailability information generated by the AP, the RA field is likewise set to a broadcast address. Conversely, when the buffer status report poll is a control frame carrying unavailability information generated by a non-AP station, the RA field is set to the address of the AP.

In another embodiment, when the start time of the unavailability interval falls within the TXOP, the BSRP-ICF or BSRP-NTB-ICF may further modify at common information field (refer Table 2 and Table 2A). In existing UHR specifications, the Common Info field of a Trigger Frame, such as a BSRP Trigger Frame, includes the GI and HE/UHR-LTF Type subfield. As illustrated in Table 2A of the current proposal, a new value ‘3’ is introduced for this subfield. According to the baseline specification, when the GI and HE/UHR-LTF Type subfield is set to 3 in an individually addressed BSRP Trigger Frame, the responding STAs transmits a non-HT (duplicate) PPDU containing a Multi-STA BlockAck (M-STA-BA) frame. In accordance with the embodiment, additional behavior is defined for the AP when transmitting a broadcast-addressed BSRP Trigger Frame that carries unavailability information. Specifically, when the GI and HE/UHR-LTF Type subfield is set to 3 in a BSRP Trigger Frame transmitted by the AP and the frame indicates the AP unavailability, the non-AP station identified in the AID 12 field of the User-Info field responds with a non-HT (duplicate) PPDU comprising a Multi-STA BlockAck frame. This enables the AP to solicit updated unavailability feedback from the designated non-AP station, even when the Trigger Frame is broadcast in nature.

Further, in another aspect of this embodiment, the Common Info field of the Trigger Frame is extended by defining a new Bit 22 (B22) as an update Flag (as shown in Table 2A) to the AP. When this bit is set, the AP indicates that the Trigger Frame contains an updated unavailability feedback request, reflecting a change or update relative to a previously transmitted broadcast Trigger Frame. This allows the AP to efficiently communicate updated coexistence-related information without relying solely on individually addressed frames, thereby ensuring timely reporting of IDC-related unavailability across all associated STAs.

TABLE 2A

| | | | | | GE And | | |
|---|---|---|---|---|---|---|---|
| | | | | | HE/UHR- | | |
| | | | | | LTF Type/ | | Number of |
| Trigger | UL | More | CS | | TXS Mode | Update | HE/UHR- |
| Type | Length | TF | Required | UL BW | (set as 3) | Flag | LTF symbols |
| Bits 4 | Bits 12 | Bits 1 | Bits 1 | Bits 2 | Bits 2 | Bits 1 | Bits 3 |
| (B0-B3) | (B4-B15) | (B16) | (B17) | (B18-B19) | (B20-B21) | (B22) | (B23-B25) |

Yet, in another embodiment, when the start time of the unavailability interval falls within the TXOP, the BSRP-ICF or BSRP-NTB-ICF may further modify at user info field (refer Table 3). In an embodiment, methods are provided for enabling unified signaling of feedback information, such as unavailability information in Trigger Frames for both the AP and the associated STAs. Certain contributions within the IEEE 802.11bn (TGbn) task group propose utilizing a special AID 12 value selected from the reserved AID 12 range to indicate the presence of unavailability information when a STAs transmits a BSRP Trigger Frame. The embodiment extends the design such that both the APs and a STAs may include a special AID 12 identifier (e.g., AID 12=2008) to signal the presence of feedback information within a Trigger Frame. The user info filed is modified as, such as, the AID 12 subfield encoding definition in the relevant table (e.g., Table 3) is extended to include the new special AID 12 value that denotes the presence of feedback information. Further the exact location of the AID 12 subfield within the Trigger Frame is formally specified. Then, the length definition of the Special User Info field (or Feedback User Info field) is introduced to support variable-length feedback content.

Table 3A represents the modified Table 3 as a format including the Special User Info field (also referred to as a Feedback User Info field) corresponding to an AID 12 value of 2008, in accordance with an embodiment of this disclosure. The field includes, among other elements, a Length field, which specifies the total number of bytes of feedback information carried. The specific feedback type is identified by bits 12 through 15 of the field, and the length corresponds to the entire feedback payload for that indicated type. Further, in this embodiment, the Special User Info field serves a dual purpose depending on the AID 12 value. When the AID 12 subfield is set to 2007, the field carries extended common information, consistent with the baseline specifications. When the AID 12 subfield is set to 2008, the field carries specific feedback information, such as unavailability information, and may be included in a Trigger Frame generated by either a UHR AP (including the AP1 or AP2) or a UHR STAs. The placement of the Special User Info field within the Trigger Frame may also be defined. When present, the Special User Info field with AID 12=2008 is located immediately after the Special User Info field having AID 12-2007, if such a preceding field exists. In the absence of an AID 12=2007 field, the AID 12=2008 field is placed immediately after the Common Info field of the Trigger Frame. Although unavailability information represents one example of feedback that may be conveyed through the Special User Info field, the disclosed design is not limited to this type of feedback. Additional feedback categories may be introduced and encoded using the same structural format, thereby enabling extensibility for future UHR features and enhancements. Accordingly, the term ‘Special User Info field’ may be used interchangeably with ‘Feedback User Info field’ without affecting scope.

TABLE 3A

| | Feedback | Length of | <<Unavailability Target Start |
|---|---|---|---|
| AID 12 | Type | Feedback | Time and Duration >> |
| Bits 12 | Bits 8 | Bits 4 | Variable (B20-variable) |
| (B0-B11) | (B12-B15) | (B16-B19) | |

As disclosed aforementioned, in an embodiment, the AP may be triggered by when it either receives or identifies a request as a control frame that signals pending uplink data from any of the associated STAs. In an embodiment, any of the STAs transmits a Buffer Status Report Poll (BSRP) Initial Control Frame (ICF) with its GE And HE/UHR-LTF Type/TXS Mode value set to 3 in order to convey unavailability information to an AP. Further in the embodiment, provided that such a BSRP-GI3 trigger frame may only be transmitted when certain conditions are to be determined and met, and that the corresponding response to the trigger control frame must be the M-STA-BA frame transmitted using the non-HT (duplicate) PPDU format. In general aspect, the BSRP-GI3 transmission with conditions such as the presence of uplink buffer data or pending uplink transmissions at any of the STAs. In an embodiment, when AP unavailability is explicitly defined within the system, the associated STAs solicit unavailability information directly from the AP immediately prior to the beginning of a transmission opportunity (TXOP). Accordingly, when the AP operates in DUO mode, the STA currently holds the TXOP and transmit a BSRP-GI3 trigger frame to solicit dynamic unavailability time information from the AP in the subsequent M-STA BA response. In this embodiment, the control frame is implemented as a BSRP ICF with its GE And HE/UHR-LTF Type/TXS Mode value set to 3, where the GI value explicitly indicates that the requesting STA seeks unavailability information from the AP immediately before the commencement of the TXOP duration as shown in FIG. 5. To support this functionality, the control frame may be modified by setting the duration field to zero. By setting the duration field to zero, the NAV of other STAs is not set, allowing all STAs to receive the M-STA BA frame broadcast or the ICR frame by the AP, which includes the unavailability information. When the duration field is set to zero, the carrier sense (CS) required field must also be set to zero, thereby ensuring that the APs performs medium sensing prior to transmitting its response. In this embodiment, the BSRP-GI3 trigger frame additionally carries duration information corresponding to the access category for which data is pending at the STA also known as an ICR duration, enabling the AP to correctly populate the duration field in the subsequent control response. Alternatively, the control frame may set the duration field to a value corresponding to the SIFS additionally with the expected response time for the M-STA BA frame, thereby adhering to baseline protocol rules. Further in the embodiment, to support the exchange of unavailability information, an Initial Control Response (ICR) duration value is incorporated within the BSRP special or feedback user information field. As shown below, in Table 3B, the ICR-duration field occupies bits 20 through 35 of the feedback or special user information subfield. Table 3B represents the modified Table 3, in accordance with an embodiment of this disclosure. The field is defined as a 2-octet or bits entity that encodes a time value in microseconds and represents the duration of the unavailability period associated with the requesting STA.

TABLE 3B

| | | | | <<Unavailability |
|---|---|---|---|---|
| AID 12 | Feedback | Length of | ICR- | Target Start Time |
| (2008) | Type (0000) | Feedback | Duration | and Duration >> |
| Bits 12 | Bits 4 | Bits 4 | Bits 16 | Bits variable |
| (B0-B11) | (B12-B15) | (B16-B19) | (B20-B35) | (B36 onwards) |

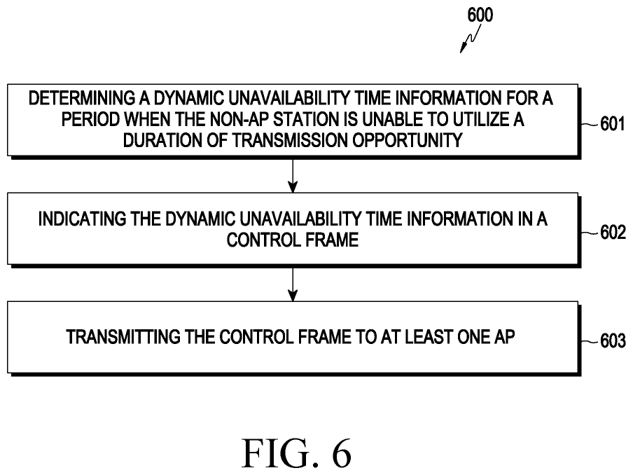

Furthermore, in the embodiment, the ICR duration of the associated STAs with the AP1, is indicated in the method operation 302 for the BSRP GI3 frame or the BSRP-NTB frame initiated by the STAs. At the STAs the ICR duration is determined by the STAs. The method operations are shown in FIG. 6 and the sequence diagram of the operations are shown in FIG. 5.

FIG. 6 illustrates a flow chart illustrating a method for indicating unavailability information of a non-AP station in a Wi-Fi system, according to an embodiment of the disclosure.

In the method operation 601 STAs determine, a dynamic unavailability time information for a period when the STAs is unable to utilize a duration of transmission opportunity, the dynamic unavailability time information comprises at least one of a start time of unavailability time slot and a duration of unavailability. At operation 602, the STA indicates the dynamic unavailability time information in the control frame. The control frame is the multi-station block acknowledgment (M-STA BA) frame with an AID-TID info subfield of the control frame using a specific AID value (as discussed in the preceding paragraph and shown in Table 3A and Table 3B). And in another embodiment, the control frame is the BSRP-NTB frame (as discussed in the preceding paragraph) and FIG. 5 description and omitted here for the sake of brevity. The method operation 603, further comprising transmitting by the STAs, the control frame to at least one mobile-AP (here AP1 in the FIG. 5) in the Wi-Fi system 101.

Furthermore, in the embodiment, the ICR-duration value is utilized by the AP when constructing the control response frame that communicates the dynamic unavailability time information. FIG. 5 further illustrates the message exchange sequence and demonstrates how the proposed formatting enables the AP to derive and set the appropriate duration value within the M-STA-BA frame containing the unavailability indication.

In another embodiment, once the conditions required to initiate the control frame identified is for second control frame or the M-STA-BA frame functions as the Initial Control Response (ICR) capable of carrying unavailability information from the APs, consistent with the agreed motions within the IEEE 802.11bn task group. Further, M-STA-BA frame may also be transmitted by a STAs in response to a BSRP-GI3 Trigger Frame that itself conveys the STA's unavailability information, as discussed in preceding paragraphs. Furthermore, for the AP, the M-STA-BA frame additionally conveys unavailability information associated with the AP or a Mobile-APs, enabling the AP to communicate coexistence-related unavailability conditions to the relevant STAs through an ICR-style response structure. Accordingly, the M-STA BA frame performs a dual role, and the corresponding frame format is designed to accommodate both functionalities, discussed in upcoming paragraphs. In an embodiment, the dual-purpose behavior of the M-STA-BA frame is taken into account in the design and extension of the frame format to ensure support for both the AP or a Mobile-AP and STAs unavailability reporting within the UHR framework.

Coming back to method operation 302, in another embodiment, once the conditions required to initiate the control frame are identified, the method at operation 302, further involves determining whether the dynamic unavailability time obtained in operation 301 falls within the transmission opportunity (TXOP) duration. If the control frame operates as M-STA BA ICR frame or the second control frame that either carries unavailability information or solicits such information, the Duration field is determined based on the relationship between the unavailability interval and the TXOP duration. When the start time of the unavailability interval falls within the TXOP, the APs sets the Duration field to a value D=T_TXOP−(Unavailability Start Time+Unavailability Duration) in the M-STA BA ICR frame, where T_TXOP represents the duration of the TXOP or TXOP duration for the associated access category. If the unavailability interval does not fall within the T_TXOP, the AP applies the legacy baseline rules for setting the Duration field. This approach enables associated STAs to recognize portions of the T_XOP during which the medium is available, allowing them to perform peer-to-peer transmissions as needed. Accordingly, when the evaluation in operation 302 determines that the dynamic unavailability time information lies within the TXOP duration, the Duration field of the control frame is set to represent the portion of the TXOP extending up to the start of the unavailability interval, excluding the unavailability duration itself. Conversely, when the unavailability interval falls outside the TXOP duration, the Duration field of the control frame is set to represent the full duration of the TXOP.

In one embodiment, when the start time of the AP's unavailability interval occurs within an ongoing TXOP, the BSRP ICF or BSRP NTB ICF may configure the Receiver Address (RA) field (see Table 4) of the second control frame to a broadcast address. Setting the RA field to a broadcast address ensures that all associated STAs are informed of the AP's impending unavailability. In this embodiment, the RA field of the second control frame is set to the broadcast address after determining, from the BA Info subfield (refer to Table 6), that the AID-TID information includes the special AID 11 value of 2008, indicating the presence of unavailability-related feedback.

In another embodiment, when the start time of the unavailability interval falls within the TXOP, the M-STA BA ICR frame may further be modified at BA control field (refer Table 5A, shown below) and BA information field (refer Table 6A-6D).

In general aspect, the M-STA-BA ICR frame supports multiple operational functions as reflected in various proposals and baseline designs. These functions include:
(1) carrying Block Ack-related information
(2) serving as an acknowledgment to an Initial Control Frame (ICF), such as a BSRP, and
(3) transporting unavailability information or other types of feedback information.

The multifunctional nature of the M-STA-BA frame, additional mechanisms are introduced to allow a receiving entity to distinguish the specific purpose for which a particular M-STA-BA is transmitted. Accordingly, special indicators or encoding methods are incorporated into the frame structure to explicitly identify the type of information being conveyed.

In an embodiment, the second control frame once determined for initiation, indicates through BA Control Field (Subfield). In the embodiment, the purpose of the M-STA-BA may be indicated through modifications to the BA Control field. In this embodiment, the second control frame (i.e., the M-STA-BA) includes a BA Control field that is enhanced as follows (refer Table 5A, below):

Bits B5 and B6 are defined as an indication flag subfield, which identifies the type of feedback or acknowledgment being conveyed.

Bit B7 is defined as an update flag used by the APs.

The update flag is set to a value of 1 when the first control frame (e.g., a BSRP) indicates that the included unavailability feedback represents an update to a previously transmitted control frame or broadcast frame comprising a broadcast address.

The indication flag subfield is configured to identify a feedback type, where the feedback type corresponds to one of a simple acknowledgment, a special feedback instance, or an acknowledgment to the first control frame. These enhancements may enable the M-STA-BA ICR to act as both a conventional acknowledgment mechanism and a carrier of extended feedback information, while clearly identifying its functional role.

TABLE 5A

| | | | | | | Memory | | |
|---|---|---|---|---|---|---|---|---|
| | | | | | No | config- | | |
| | BA | Indication- | Update - | | Memory | uration | Manage- | TID |
| Reserved | Type | Flag | Flag | Reserved | Kept | Flag | ment Ack | Info |
| Bits 1 | Bits 4 | Bits 2 | Bits 1 | Bits 1 | Bits 1 | Bits 1 | Bits 1 | Bits 4 |
| (B0) | (B1-B4) | (B5-B6) | (B7) | (B8) | (B9) | (B10) | (B11) | (B12-B15) |

In this embodiment, the encoding of the indication flag may follow the structure defined in Table 7 below.

TABLE 7

| Indication Flag | | |
|---|---|---|
| B5 | B6 | Description |
| 0 | 0 | Carries baseline Block Ack only |
| 0 | 1 | Contains Special AID 11 value without Block Ack |
| 1 | 0 | Is an ACK to ICF. No further BA information is present |
| 1 | 1 | Contains Special AID 11 value with Multi-STA Block |
| | | Ack |

In another aspect of this embodiment, the use of reserved AID values to encode supplemental information enables the receiving entity to determine the relevant information type without scanning the Per-AID-TID-Info fields. As a result, the receiver can pre-configure its decoder buffers based on the special AID value alone, thereby reducing processing overhead and improving robustness in the presence of multiple feedback types

In another embodiment, the second control frame, once determined for initiation, indicates through BA Information Field. In the embodiment, the purpose of the M-STA-BA may be indicated through modifications to the BA Information Field. In this embodiment, the second control frame (i.e., the M-STA-BA) includes a BA Information Field that is enhanced as follows.

Further, in another embodiment, the purpose of the M-STA-BA frame is indicated through the BA Information field. In this embodiment, the M-STA-BA includes a BA Information field that is modified to incorporate acknowledgment and feedback indicators, as described below (refer Table 8, below):

An ack type subfield and a TID subfield are configured to indicate the presence or absence of feedback information.

The ack type subfield is set to 0, and the TID subfield is set to 13, when the M-STA-BA frame carries feedback information, including but not limited to unavailability information.

The ack type subfield is set to 1, and the TID subfield is set to 13, when the M-STA-BA frame serves only as an acknowledgment to the first control frame and does not contain any feedback information. This setting identifies the frame as conveying ICR context without feedback content.

Through this indication structure, the M-STA-BA can unambiguously encode whether it is functioning strictly as an acknowledgment or additionally as a feedback-carrying ICR frame.

TABLE 8

| | | Presence of Block | |
|---|---|---|---|
| | | Ack Starting Sequence | |
| Ack Type | TID | Control subfield and | Context of a Per AID |
| Subfield | Subfield | Block Ack Bitmap | TID Info subfield in a |
| values | values | subfields | Multi-STA BlockAck frame |
| 0 | 13 | Present | Feedback context: |
| | | | Sent as feedback (e.g., of |
| | | | unavailability) |
| 1 | 13 | Not Present | This is an ACK to the ICF |
| | | | (e.g., BSRP). ICR Context |

Coming back to FIG. 3, the method operation 303, the control frame as discussed above and or with the control frames discussed below are transmitted to one or more associated or unassociated STAs. The transmission of the control frame and type of control frame depends upon the requirements and based on the previous transmission. The conditions of initiation of the first and second control frame are discussed in aforementioned disclosure and related drawings (refer FIGS. 4A, 4B, 5, and 6) and rest of the initiating conditions with type of frame related to management and legacy frames are discussed in upcoming paragraphs (refer FIGS. 7A, 7B, 8A, 8B, and 9). In an embodiment, FIGS. 7A and 7B illustrates a sequence diagram illustrating the method of an AP and non-AP STA indicating unavailability feedback in the control frame respectively.

Yet, in another embodiment, as discussed in the method operation 302 upon determining dynamic unavailability time information, the APs transmits an unavailability announcement in a broadcast frame such as a beacon, association response, probe response, or action frame. The unavailability announcement is encoded as feedback information using either an Element ID (as shown in Table 9) or a UHR Operation Element (as shown in Table 10) or a parameter update element. When included in the UHR Operation Element, a feedback type field identifies the information as unavailability time information, and the element further specifies an unavailability start time and unavailability duration. In one example, a feedback type value of ‘01’ indicates unavailability. Table 9 represents the general frame format and Table 9A represents the description of frame format of Element ID added in Table 9 (prior frame), in accordance with an embodiment of the disclosure.

TABLE 9

| | | Element ID | | |
|---|---|---|---|---|
| Element | Element ID | Extension | Extensible | Fragmentable |
| Feedback | 255 | <ANA> | Yes | No |
| Information | | | | |

TABLE 9A

| | | | | |
|---|---|---|---|---|
| Element ID | Length | Element ID | Unavailability | Unavailability |
| | | Extension | Start Time | Duration |

Further Table 10 represents a modified frame format of UHR Operation element subfield containing presence bitmap, in accordance with another embodiment of the disclosure.

TABLE 10

| | NPCA | | | | | | |
|---|---|---|---|---|---|---|---|
| | Operation | | | | | | |
| | Information | | | | | Unavail- | Unavail- |
| DPS | Element | Feedback | | | Feedback | ability | ability |
| Enabled | present | Information | Reserved | Reserved | Type | Start Time | Duration |
| Bits 1 | Bits 1 | Bits 1 | Bits 3 | Bits | Bits 2 | Bits 9 | Bits 9 |
| | | | | variable | | | |

In an embodiment, in the UHR Operation element, Feedback information present bit indicates that Feedback Information field is added. The format of the Feedback Information field is as shown in Table 11. The encoding of Feedback Type can be 01 for Unavailability and the rest of the values are reserved for future use.

TABLE 11

| Feedback Type | Unavailability Start Time | Unavailability Duration |
|---|---|---|
| Bits: 2 | Bits: 9 | Bits: 9 |

Further, the embodiment is illustrated through sequence diagram as shown in FIG. 8A that illustrates a Beacon sending a broadcast information that carries feedback of unavailability followed by an ICF-ICR frame exchange, in accordance with an embodiment of this disclosure. FIG. 8B, illustrates an unsolicited unavailability announcement frame (e.g. action frame) can be sent to achieve the same, in accordance with an embodiment of this disclosure.

In one embodiment, a M-STA-BA frame defined in aforementioned paragraphs, as for carrying block acknowledgment bitmaps for TB PPDUs that is extended to also transport unavailability information for DUO-enabled devices. A DUO STAs may embed unavailability start time and duration using the special AID 11 value in the Per-AID-TID Info field when generating a regular M-STA-BA during the acknowledgment procedure. If the STAs did not have unavailability information at the start of the TXOP, it may include the information once it becomes available during a later M-STA-BA opportunity. Similarly, a DUO AP or the Mobile-AP may include its own unavailability information in an M-STA-BA generated under the standard acknowledgment procedure, also using the special AID 11 value to indicate the presence of unavailability feedback. FIG. 8A illustrates an example in which a DUO non-AP station, after beginning a TXOP without unavailability information during the initial ICF-ICR exchange, later inserts the unavailability report into an M-STA-BA once the information becomes available according to an embodiment of the disclosure. FIG. 8B illustrates an example where a DUO AP, operating in DUO mode, embeds its unavailability start time and duration within a regular M-STA-BA transmitted as part of the acknowledgment procedure according to an embodiment of the disclosure.

In one embodiment, the AP communicates its unavailability information using broadcast messages, such as Beacon frames, ICF-ICR exchanges, or other management frames, to ensure that all STAs in the BSS can receive the unavailability timing information, as illustrated in FIGS. 9A and 9B. After transmitting the beacon frame, AP processes only a single unavailability report from any of the STAs, this constraint cannot be applied in reverse for STAs processing APs unavailability reports, because the AP may update its coexistence status multiple times. In this embodiment, the APs includes an update flag within the ICF-ICR signaling to indicate whether a coexistence report represents an update relative to a previously broadcast unavailability report, such as one transmitted through a beacon or an unannounced unavailability report. When any of the STAs detects that the update flag is set, it processes the full unavailability report contained in the broadcast frame. If the update flag is not set, the non-AP station may ignore the report. A STAs that did not receive the earlier broadcast for example, due to temporary channel conditions ignores the update flag and instead reads the full unavailability report to ensure it obtains the most recent Aps's coexistence information.

Any bits assigned to a specific modification, designation, new field, or update under this disclosure are not limited to the particular bits explicitly identified herein. Such modifications may be applied to any unreserved bits within the frames disclosed in the specification, as illustrated in the modified or unmodified tables of this disclosure. The designation of bits is provided solely to describe the use of bits for conveying information within the frames to implement the method operations of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an access point (AP) for indicating unavailability information in a wireless local area network (WLAN) communication system, the method comprising:
determining dynamic unavailability time information for a period during which the AP is unable to utilize a duration of transmission opportunity and the dynamic unavailability time information includes at least one of a start time of unavailability time slot or a duration of unavailability;
indicating the dynamic unavailability time information in a control frame; and
transmitting, to at least one non-AP station, the control frame.

2. The method of claim 1,
wherein the control frame includes one of a first control frame or a second control frame,
wherein the first control frame includes one of a buffer status report poll (BSRP) initial control frame (ICF) or a BSRP-non trigger based (BSRP-NTB) ICF, and
wherein the second control frame includes a multi-station block acknowledgment (M-STA BA) initial control response (ICR).

3. The method of claim 2, wherein the first control frame is initiated in case that the AP has monitored at least one of:
a downlink buffered data for the at least one non-AP station;
a buffer status report indicating pending uplink data from the at least one non-AP station; or
a buffered downlink control or management frame to transmit.

4. The method of claim 2,
wherein the second control frame is initiated in case that the AP receives a request from the at least one non-AP station, and
wherein the request is received in form of the first control frame.

5. The method of claim 1, wherein indicating the dynamic unavailability time information in the control frame comprises:
determining whether the dynamic unavailability time information is included in the duration of transmission opportunity, and
wherein,
(a) in response to determining that the dynamic unavailability time information is included in the duration of transmission opportunity, a duration field of the control frame includes the duration of transmission opportunity up to the start time of unavailability information excluding the duration of unavailability; and
(b) in response to determining that the dynamic unavailability time information is not included in the duration of transmission opportunity, the duration field of the control frame includes the duration of the transmission opportunity.

6. The method of claim 1, wherein, in case that the AP includes the dynamic unavailability time information and sets a duration field in a first control frame, a receiver address field of the first control frame is set as a broadcast address.

7. The method of claim 2,
wherein indicating the dynamic unavailability time information in the first control frame comprises modifying the dynamic unavailability time information at a common information field;
wherein modifying the dynamic unavailability time information comprises:
setting a guard interval (GI) and high efficiency/ultra-high reliability-long training field (HE/UHR-LTF) subfield to a value of three;
defining an update flag for the AP in the first control frame; and
setting the update flag value as one, indicating unavailability feedback to a previously transmitted control frame or broadcast frame including a broadcast address.

8. The method of claim 7,
wherein the first control frame further includes a user information list block,
wherein the method further comprising:
modifying the user information list block, and
wherein the modifying of the user information list block including:
indicating a presence of the unavailability feedback by a special association identifier 12 (AID 12) subfield, the AID 12 subfield being set to a value of 2008, the unavailability feedback being received from the at least one non-AP station or from the AP including the dynamic unavailability time information,
indicating a length of the unavailability feedback in response to the indicating of feedback type as the special AID 12 subfield, and
configuring, a location of special AID 12 subfield with the value of 2008, wherein the special AID 12 subfield with the value of 2008 is located either immediately after a special AID 12 subfield set having value 2007; or immediately after the common info field of the first control frame.

9. The method of claim 2,
wherein the second control frame further includes a block acknowledgement (BA) control field,
wherein the method further comprising:
modifying the BA control field,
wherein the modifying of the BA control field comprises:
determining that an association identifier-traffic identifier (AID-TID) information field includes a special association identifier 11 (AID 11) value that is set to 2008, and
in response to the determining that the AID-TID information field includes the special AID 11 value that is set to 2008, setting a receiver address (RA) field to a broadcast address.

10. The method of claim 2,
wherein the second control frame further includes a block acknowledgement (BA) control field,
wherein the method further comprising:
modifying the BA control field, wherein the modifying of the BA control field comprises:
defining a set of bits as an indication flag subfield and as an update flag;
setting the update flag to a value of one in response to the first control frame indicating that included in the unavailability feedback is an update to a previously transmitted control frame; and
configuring the indication flag subfield to identify a feedback type, the feedback type being one of a simple acknowledgement, additional special feedback, or an acknowledgement to the first control frame.

11. The method of claim 2,
wherein the second control frame further includes a block acknowledgement (BA) information field,
wherein the method further comprises modifying, by the AP, the BA information field,
wherein the modifying of the BA information field comprises:
configuring an acknowledgment (ack) type subfield and a traffic identifier (TID) subfield to indicate a presence or an absence of feedback information;
setting the ack type subfield value to zero and the TID subfield value to thirteen, indicating that the second control frame includes the feedback information; and
setting the ack type subfield value to one and the TID subfield value to thirteen, indicating that the second control frame with ICR context serves as an acknowledgment to the first control frame and does not contain any feedback information.

12. The method of claim 1,
wherein, in response to determining the dynamic unavailability time information, the method further comprises indicating an unavailability announcement in a broadcast frame, the broadcast frame being at least one of a beacon frame, an association response, a probe response, or an action frame,
wherein the unavailability announcement includes a feedback information present,
wherein the indicating of the unavailability announcement is defined in one of:
an element identifier (ID),
an operation element, or
a parameter update element;
wherein, in case that the feedback information present indicates a feedback type, and when the feedback type is the unavailability time information, the feedback information further indicates the start time of unavailability time slot and a duration of unavailability, and
wherein the feedback type is set to a value of ‘01’ to indicate unavailability.

13. A method performed by a non-access point (AP) station for indicating unavailability information in a wireless local area network (WLAN) communication system, the method comprising:
determining dynamic unavailability time information for a period during which the non-AP station is unable to utilize a duration of transmission opportunity and the dynamic unavailability time information includes at least one of a start time of unavailability time slot or a duration of unavailability;
indicating the dynamic unavailability time information in a control frame; and
transmitting, to at least one AP, the control frame.

14. The method of claim 13,
wherein the dynamic unavailability time information is indicated in the control frame, the control frame being a multi-station block acknowledgment (M-STA BA) frame, and
wherein the method further comprises indicating the dynamic unavailability time information in an association identifier-traffic identifier (AID-TID) information field using a specific association identifier (AID) value, during the duration of transmission opportunity.

15. The method of claim 13, wherein the dynamic unavailability time information is indicated in the control frame, the control frame being a buffer status report poll-non trigger based (BSRP-NTB) frame.

16. The method of claim 15, wherein the control frame is modified as:
(a) setting a duration field to a value zero, allowing all non-AP stations to receive an initial control response (ICR) frame from the at least one AP including the dynamic unavailability time information, and
(b) including an ICR duration, the ICR duration indicating the duration of transmission opportunity required by the non-AP station.

17. The method of claim 15, the control frame is alternatively modified as:
setting a duration field to a value including short inter-frame space (SIFS) and a response time to be utilized by the control frame.

18. The method of claim 16, wherein, in case that the duration field is set to the value of zero, then:
setting a carrier sense (CS) required field to a value of zero, ensuring the at least one AP senses a transmission medium before transmitting the ICR frame.

19. An access point (AP) indicating unavailability information in a wireless local area network (WLAN) communication system, the AP comprising:
memory, comprising one or more storage media, storing one or more computer programs;
a wireless transceiver configured to communicate with at least one external device; and
at least one processor communicatively coupled to the memory and the wireless transceiver,
wherein the at least one computer programs include computer executable instructions that, when executed by the at least one processor individually or collectively, cause the AP to:
determine dynamic unavailability time information for a period during which the AP is unable to utilize a duration of transmission opportunity and the dynamic unavailability time information includes at least one of a start time of unavailability time slot or a duration of unavailability,
indicate the dynamic unavailability time information in a control frame, and
transmit, to at least one non-AP station, the control frame.

20. A non-access point (AP) station indicating unavailability information in a wireless local area network (WLAN) communication system, the non-AP station comprising:
memory, comprising one or more storage media, storing one or more computer programs;
a wireless transceiver configured to communicate with at least one external device; and
at least one processor communicatively coupled to the memory and the wireless transceiver,
wherein the at least one computer programs include computer executable instructions that, when executed by the at least one processor individually or collectively, cause the non-AP station to:
determine dynamic unavailability time information for a period during which the non-AP station is unable to utilize a duration of transmission opportunity and the dynamic unavailability time information includes at least one of a start time of unavailability time slot and a duration of unavailability,
indicate the dynamic unavailability time information in a control frame, and
transmit, to at least one AP, the control frame.
